(19) United States
(12) Patent Application Publication
(10) Pub. No.: US 2009/0304217 A1
(43) Pub. Date: Dec. 10, 2009

(54) APPARATUS AND METHOD FOR USING A PORTABLE MEDIA UNIT

(75) Inventors: Richard J. Thalheimer, San Francisco, CA (US); Edward C. McKinney, Novato, CA (US); Frederick M. Schechter, Oakland, CA (US); Eric C. Blair, San Rafael, CA (US); Shek Fai Lau, Foster City, CA (US)

Correspondence Address: BELL, BOYD & LLOYD LLP, P.O. BOX 1135, CHICAGO, IL, 60690, US

(73) Assignee: SHARPER IMAGE CORPORATION, San Francisco, CA (US)

(21) Appl. No.: 11/719,286

(22) PCT Filed: Nov. 14, 2005
(86) PCT No.: PCT/US2005/041224

§ 371 Date: Jul. 10, 2009

Related U.S. Application Data
(63) Continuation of application No. 11/156,867, filed on Jun. 20, 2005, now Pat. No. 7,399,198.
(60) Provisional application No. 60/627,332, filed on Nov. 12, 2004.
(60) Provisional application No. 60/627,205, filed on Nov. 12, 2004.
(60) Provisional application No. 60/627,204, filed on Nov. 12, 2004.
(60) Provisional application No. 60/627,203, filed on Nov. 12, 2004.
(60) Provisional application No. 60/627,354, filed on Nov. 12, 2004.
(60) Provisional application No. 60/627,331, filed on Nov. 12, 2004.
(60) Provisional application No. 60/627,331, filed on Nov. 12, 2004.
(60) Provisional application No. 60/627,353, filed on Nov. 12, 2004.
(60) Provisional application No. 60/609,592, filed on Sep. 13, 2004.
(60) Provisional application No. 60/627,332, filed on Nov. 12, 2004.
(60) Provisional application No. 60/611,051, filed on Sep. 16, 2004.
(60) Provisional application No. 60/663,942, filed on Mar. 21, 2005.

(51) Int. Cl. H04R 1/02; H04N 7/18; H04B 7/00; G06F 17/00

(52) U.S. Cl. 381/334; 348/151; 455/41.2; 700/94; 348/E07.085

(57) ABSTRACT

An apparatus includes a housing, a holder coupled to the housing, an output device coupled to the housing, and a cable module. The cable module includes a cable configured to move relative to the cable module and connect with a portable media device located within the holder to communicate a media signal from the portable media device to the output device.

### CLAIM OF PRIORITY

This application claims priority to U.S. patent application Ser. No. 11/156,867 entitled “Device with Speaker and Retractable Cable Unit” filed Jun. 20, 2005; U.S. Provisional Application No. 60/627,205 entitled “Portable TV Player that Connects to Portable Media Unit” filed Nov. 12, 2004; U.S. Provisional Application No. 60/627,354 entitled “Weatherproof Speaker Wirelessly Connected to Portable Media Unit” filed Nov. 12, 2004; U.S. Provisional Application No. 60/627,353 entitled “Use of Environmental Inputs to Control Portable Media Unit” filed Nov. 12, 2004; U.S. Provisional Application No. 60/627,331 entitled “Enclosed Docking Station for Portable Media Unit” filed Nov. 12, 2004; U.S. Provisional Application No. 60/627,203 entitled “Household Objects Connecting to Portable Media Unit” filed Nov. 12, 2004; and U.S. Provisional Application No. 60/627,204 entitled “Wireless System for Portable Media Unit” filed Nov. 12, 2004, each of which is incorporated herein by reference in its entirety.

### BACKGROUND OF THE INVENTION

Portable media units such as MP3 players and other digital and/or analog music players have become quite popular in recent years. Some portable media units use a hard disk or flash memory to store music files, such as MP3s. Such portable media units use these music files to create an audio signal. The audio signal created by the portable media unit is typically sent to an output such as, for example, a headphone jack on the portable media unit. Headphones or an external speaker can be plugged into the audio output jack so that the user can listen to the music. Some portable media units also have proprietary connections for use in transferring music files and signals as well as providing power to the portable media unit.

### BRIEF DESCRIPTION OF THE DRAWINGS

FIGS. 1A and 1B are perspective views of a device with a speaker of one embodiment of the present invention.

FIGS. 2A and 2B illustrate a device with a retractable cable module of one embodiment of the present invention; FIG. 2A shows the cable in a retracted position, and FIG. 2B shows the cable in an extended position.

FIG. 3 is a cross-sectional diagram of an exemplary retractable cable module of one embodiment of the present invention.

FIG. 4 is an exploded diagram of components of the retractable cable module of one embodiment of the present invention.

FIG. 5 is a diagram that illustrates an embodiment where the plug fits against a surface shaped to hold the plug.

FIG. 6A is a perspective view of a retractable cable module of one embodiment.

FIG. 6B is a diagram of a retractable cable module that fits in a slot of a device with a speaker.

FIG. 7 illustrates a retractable cable module attached to the outside of the housing of a device with a speaker.

FIG. 8 illustrates a device with a speaker, the device having a recess for storing a cable for connection to a portable media unit.

FIGS. 9A-9C illustrate holders for a portable media unit including a retractable cable module.

FIGS. 10A-10D illustrate a removable module of one embodiment.

FIG. 11 illustrates a removable module of an alternate embodiment.

FIGS. 12A-12D illustrate one embodiment of a holder for a removable module.

FIG. 13 illustrates an alternate embodiment of a holder for a removable module.

FIG. 14A illustrates a chair with a retractable cable module.

FIG. 14B illustrates a chair with a port connector for a portable media unit.

FIG. 15 illustrates a chair with a port connector for a portable media unit.

FIG. 16 illustrates a chair with a wireless connection unit for connecting to a local unit such as a portable media unit.

FIGS. 17 and 18 illustrate a chair with removable speakers that have a wireless connection unit.

FIG. 19 is a functional diagram of a chair of one embodiment.

FIG. 20 is a diagram that illustrates a system for using an environmental input to affect a portable media unit.

FIG. 21 is a diagram that illustrates a connection of a portable media unit with an environmental input unit such that the environmental input can be used to affect the operation of the portable media unit.

FIG. 22 is a diagram of a system in which the portable media unit has an ID tag which can be used to affect the operation of the portable media unit.

FIG. 23 is a diagram that illustrates a wireless connection between a portable media unit and an ID tag so that ID can affect the operation of the portable media unit.

FIG. 24A is an illustration of a waterproof device with speakers wirelessly connected to a portable media unit.

FIG. 24B is a device of another wireless device with speakers wirelessly connected to a portable media unit.

FIGS. 25A and 25B are diagrams of a waterproof device having a compartment to fit a portable media unit.

FIG. 26 is a functional diagram of a waterproof device of one embodiment.

FIG. 27 is a diagram of a wireless system for a portable media unit of one embodiment of the present invention.

FIG. 28 is a diagram that illustrates a nanny cam of one embodiment of the present invention.

FIG. 29 is a functional diagram of a nanny cam of one embodiment of the present invention.

FIG. 30 illustrates a connector for a nanny cam of one embodiment of the present invention.

FIG. 31 illustrates a picture frame of one embodiment of the present invention that interacts with a portable media unit.

FIG. 32 is a functional diagram of a picture frame unit of one embodiment of the present invention.

FIGS. 33A-33B are diagrams of a portable video player which has a connector for connecting to a portable media unit.

FIG. 34 is a diagram of a portable media unit wirelessly connected to a portable video player.

FIG. 35 is a functional diagram of a portable video player which can interconnect with a portable media unit.

FIG. 36 is a diagram that illustrates a computer tower with an enclosure unit of one embodiment of the present invention.

FIG. 37 is a diagram that illustrates an enclosure unit of the embodiment of FIG. 36.

FIG. 38 is a diagram that illustrates a computer tower with an enclosure unit of another embodiment of the present invention.

FIG. 39 is a diagram that illustrates the enclosure unit of FIG. 38.

FIG. 40 is a diagram of a device for attachment to a computer.

### DETAILED DESCRIPTION OF THE INVENTION

According to one embodiment of the present invention, a cable module is attached to the housing of a device including at least one speaker. The cable module can include a connection cable with a plug connectable to a portable media unit to provide an audio signal to the speaker. The cable can be retractable or non-retractable. In an embodiment utilizing a retractable cable, the cable can be moveable between an extended position and a retracted position.

The cable module allows the user to extend the cable from the device to the portable media unit. The user need not plug the cable into the device each time a connection is to be made, nor need there be any loose wires connected to the back of the device. In the embodiment in which the cable is retractable, the retractable cable module can use a tensioning spring to wind the cable in from the extended position to the retracted position. The housing of the device can also include a mount for the portable media unit.

According to another embodiment of the invention, a portable media player mount is adapted to be removably or permanently positioned on a device with a speaker, and wherein the mount incorporates a cable module with a plug connectable to a portable media unit such as a portable music player. Still further embodiments of the invention include a cable module that can be selectable and removably mounted into a port or recess of a housing of a device with at least one speaker. Insertion of the retractable or non-retractable cable module can simultaneously make electrical contact between contacts on the outside of the cable module and the port or recess of the housing.

Further embodiments of the present invention concern the use of a portable media unit, such as an MP3 player. The portable media unit can be any portable unit including an MP3 player, a radio, a Compact Disk (CD) player or a video player, such as a portable digital video player that stores digital video files. The portable media unit can include memory, such as a hard disk and or flash memory, a processor, operating software, display screens, connectors, input elements, speakers and/or ear phones.

In accordance with another embodiment, an environmental input is used to affect the operation of the portable media unit. The portable media unit can be affected by modifying displays based upon the environmental input, automatically selecting a playlist based on the environmental input or in some other fashion, and playing the songs in the playlist.

The environmental input can be a weather indication such as temperature, humidity, rainfall, wind speed, etc., or another environmental input such as an indication of time. The portable media unit can store different playlists for different value ranges of the environmental input. For example, a playlist for cold weather and a playlist for warm weather can be stored. The portable media unit can automatically play a “weather” playlist based upon the environmental input. In one embodiment, a separate device can be used to determine the environmental input. In one embodiment, the portable media unit displays an indication of a selected playlist. For example, the portable media unit can include a “weather” playlist, which can vary based upon the environmental input. This “weather” playlist can be selected by the user or automatically selected upon some event.

In accordance with another embodiment, a personal identification (ID) can be used to automatically affect the operation of the portable media unit. The personal ID can be provided by a personal identification unit. The personal ID can affect the operation of the portable media unit including the display of the portable media unit.

In accordance with another embodiment, a waterproof device includes waterproof speakers and a wireless connection unit adapted to obtain an audio signal from a portable media unit. The waterproof device keeps the wireless connection unit free from water.

The waterproof device can be waterproof in whole or in part. The waterproofing can include seals to isolate doors, compartments and control inputs, and a coating, such as a plastic coating, to cover speakers and/or displays.

Further embodiments of the present invention concern the use of a portable media unit, such as an MP3 player, with a household object such as a nanny cam or a picture frame display.

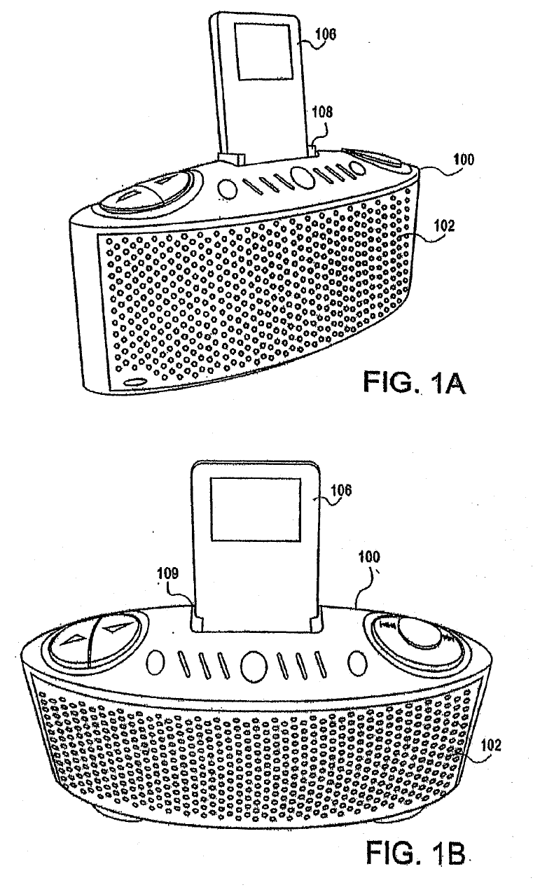

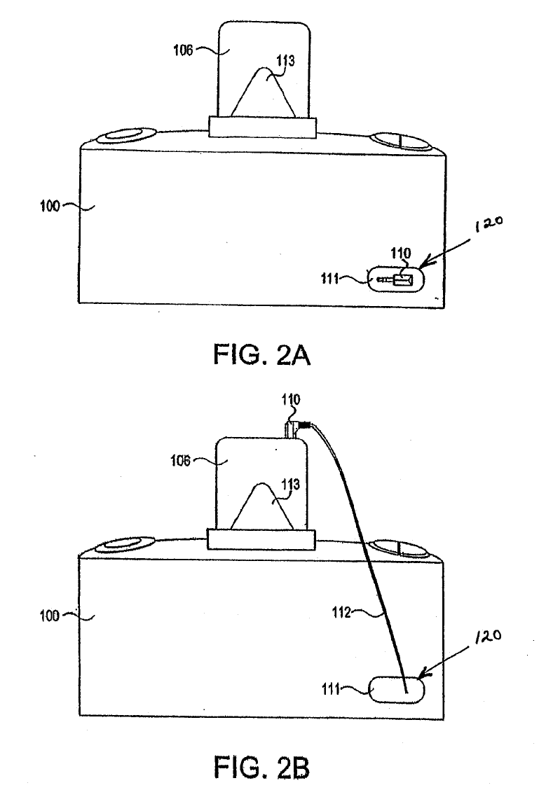

Referring to FIGS. 1A, 1B, 2A and 2B, a device 100 includes a housing, at least one speaker 102 within the housing, and a retractable cable module 120 (FIGS. 2A and 2B) attached to the housing. The retractable cable module 120 can include a connection cable 112 and a plug 110 connectable to a portable media unit 106 to provide an audio signal to the speaker 102. The cable 112 is movable between an extended position and a retracted position. Preferably, a portion of the cable 112 is extended outside of the retractable cable module 120 in the extended position, but, preferably, not in the retracted position. In one embodiment, the retractable cable module 120 is positioned within the housing. In another embodiment, the retractable cable module 120 is permanently affixed to or included in the housing with the speaker 102. In another embodiment, the retractable cable module is removably positionable on or in the housing with the speaker 102. In yet another embodiment, the cable 112 has a predefined length and is not retractable as shown, for example, in FIG. 8.

FIGS. 1A and 1B illustrate an embodiment of the device 100 including at least one speaker 102. Devices 100 with at least one speaker 102 can include tape players, CD players, stand-alone speakers, radios, sound generators, audio-visual systems and the like. FIGS. 1A and 1B illustrate an embodiment in which a portable media unit 106 can be positioned on the device 100 in a holder 108. The portable media unit 106 can be any portable unit including an MP3 player, a radio, a Compact Disk (CD) player or a video player, such as a portable digital video player that stores digital video files (and in which an audio component of the video signal can be played through the speakers 102). In this embodiment, the holder 108 includes a well or recess 109 which is adapted to receive the bottom of the portable media unit 106 as well as a backrest 113 (FIG. 2A) against which the portable media unit 106 can lean against. A multimedia signal can be an audio, a visual or a combined audio and video signal. In one embodiment, the holder 108 is adapted to receive the bottom of the portable media unit 106 and creates sufficient support for the portable media unit 106 such that the backrest 113 and/or well or recess 109 is not required to fully support the portable media unit 106.

FIGS. 2A and 2B illustrate an embodiment in which the retractable cable module 120 is employed, and further illustrate the movement of the cable 112 from the retracted position to the extended position. As shown in FIG. 2A, in the retracted position, the plug 110 can be positioned adjacent to the housing of the device 100. In this embodiment, the plug 110 can be positioned in a recess 111. As shown in FIG. 2B, the cable 112 can be pulled out so that the plug 110 can be connected to the portable media unit 106. In this embodiment, the retractable cable module can allow for the cable 112 to be extended to a variety of lengths so there is effectively a range of extended positions. The cable 112 can transfer an audio signal which can be any type of analog or digital audio signal or file, a video signal, or a combined audio and video signal. In one embodiment, the plug 110 is a stereo music plug, such as a 3.5 mm stereo plug. In some embodiments, the plug 110 and cable 112 may also transfer power to the portable media player 106.

In one embodiment, the device 100 auto-detects when the plug 110 is connected to the portable media unit 106. This can be done by detecting when the plug 110 is placed within a jack of the portable media unit 106, by detecting a signal from the portable media unit 106, or by some other means. When the device 100 detects that the plug 110 is connected to the portable media unit 106, the device 100 can interrupt any other audio sources of the device 110. Alternately, the device 100 can wait until the audio signal is detected from the portable media unit 106 to interrupt any other audio source. The retractable cable module 120 can act as an auxiliary audio input for the device 100.

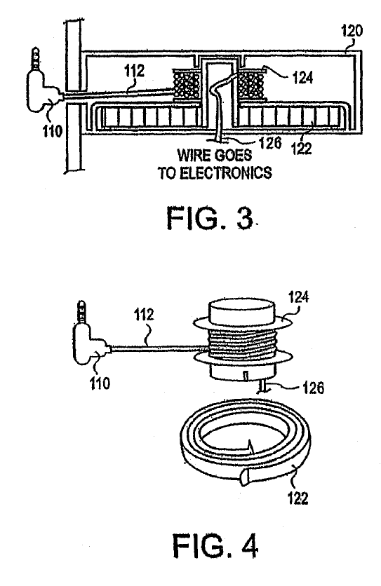

FIG. 3 illustrates an exemplary retractable cable module 120 of the present invention. People skilled in the art will understand that alternate retractable cable module designs can be used. In the example of FIG. 3, the retractable cable module 120 includes a coiled tensioning spring 122 and a spool 124. The tensioning spring 122 can be used to wind up the cable 112 on the spool 124. The other end 126 of the cable 112 can be permanently attached to the electronics of the device 100 or can have a second plug to plug into a jack of the device 100. As the cable 112 is pulled from the retractable cable module 120, the tensioning spring 122 stores energy. The tensioning spring 122 can use this stored energy to pull in the cable 112 from the extended position to the retracted position.

The retractable cable module 120 can include a ratchet (not shown) for holding the cable 112 in an extended position. The ratchet can be operably connected to the spool 124 to hold the spool 124 and thus the cable 112 in the extended position. When the ratchet is disengaged, the cable 112 can then be pulled back into the retractable cable module 120 under the tension provided by the tensioning spring 122. The ratchet can be disengaged using an external button or by slightly pulling on the cable 112.

FIG. 4 illustrates an exploded view of components of the retractable cable module 120 of one embodiment, including the tensioning spring 122 and the spool 124. The tensioning spring 122 can be a metal ribbon coil that is connected to the spool 124.

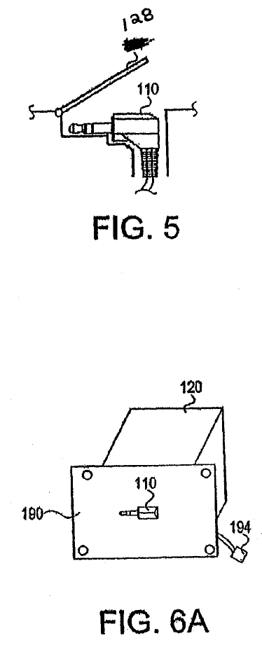

FIG. 5 illustrates an embodiment where the plug 110 fits against a surface shaped to hold the plug 110. A door 128 can be used to provide access to the plug 110. The door 128 can tilt, pivot, slide or open in some other fashion. A mechanism can be used such that when the plug 110 or door 128 is pushed on, the plug 110 is released freeing some of the cable 112 so that the cable 112 can be easily removed. Such a mechanism can include a latch with a spring.

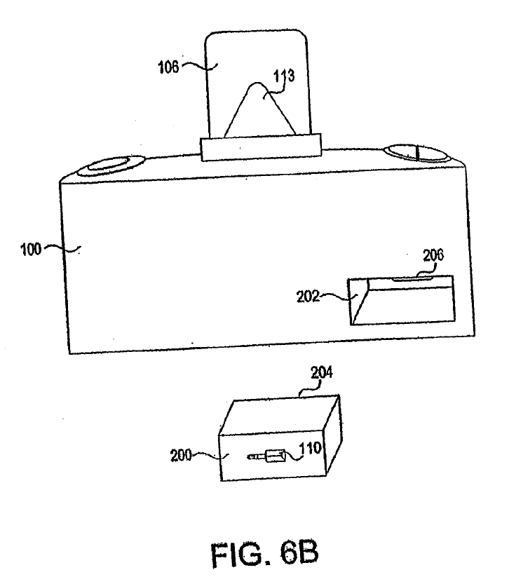

In an embodiment employing a retractable cable, the retractable cable module 120 can be removable from the device 100. FIG. 6A illustrates an example in which the retractable cable module 120 is a removable module 190. In this example, the module 190 can be screwed into the housing of the device 100. In one embodiment, a second plug 194 of the module 190 can connect to the device 100. After the module 190 is partially removed from the device 100, the plug 194 can be unplugged from the device. This can allow for easy service or replacement of the module 190. In one embodiment, the housing can have a door to allow access to the retractable cable module 120.

As shown in FIG. 6B, a module 200 with the retractable cable can fit into a slot 202 in the housing of the device 100. The module 200 can click into place or be held in place by friction. The module 200 can have a connector 204 on the module housing to operably connect to a connector 206 on the device 100. The connectors 204 and 206 can be used to transfer an audio signal, a video signal, or a combined audio and video signal from the module 200 into the device 100. The connectors 204 and 206 can also be used to transfer power from the device 100 to the portable media unit 106.

The device 100 can also use other modules that fit into the same slot 202 of the device 100. For example, a female input module or other auxiliary input connection port module can be used interchangeably with the retractable cable module. The auxiliary input connection can be of the type found on the back of a conventional stereo sound system, male or female, can be a connection such as that used by cartridges in video game counsels, can be a connection such as that used with conventional memory cards, can be a connection such as that used to connect peripherals to a computer or laptop, or the like.

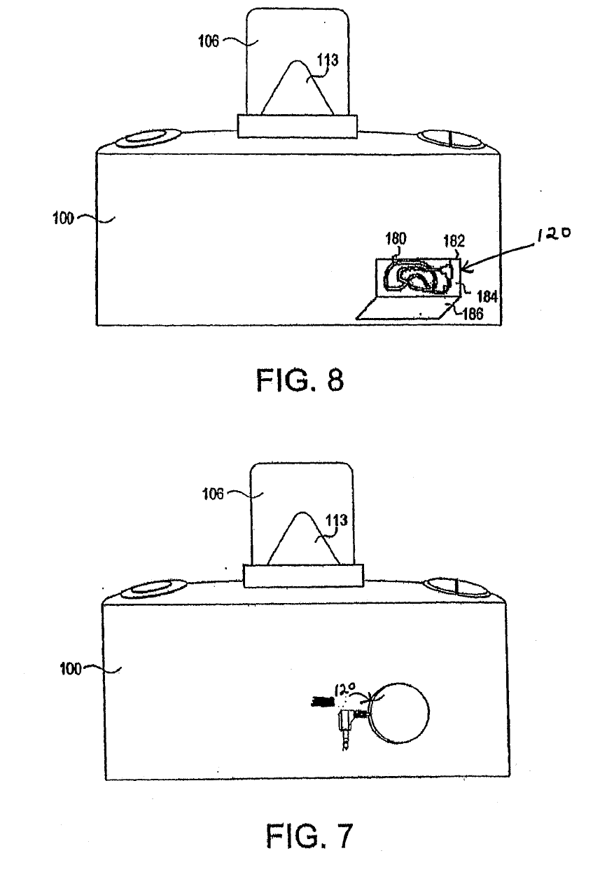

The retractable cable module 120 can be partially or completely within the housing as shown in FIG. 3. Alternately, as shown in FIG. 7, the retractable cable module 120 can be attached to the outside of the device 100. The retractable cable module 120 can be attached with screws, bolts, sticky pads or adhesive to the outside of the housing. The retractable cable module 120 can use a second plug 194 to, for example, plug into an auxiliary input of the device 100 or make some other operable connection to the device 100 in a manner similar to that described above relating to the auxiliary input connection. In another embodiment, the retractable cable module 120 can be removably or permanently inserted into a port or recess of the housing of the device 100 with the speaker 102.

In one embodiment, other ways of storing a non-retractable cable 180 in the housing of the device 100 can be used. FIG. 8 illustrates one embodiment in which the device 100 includes a recess 184 for storing the non-retractable cable 180 with the plug 182 within the housing. In one embodiment, the housing can include a door 186 that closes over the recess 184. The plug 182 can be removed from the housing and connected to the portable media unit 106. The non-retractable cable 180 and plug 182 can be returned to the housing after use.

One embodiment of the present invention includes a holder 150 for a portable media unit 160 comprising a holder body to receive the portable media unit 160 and a cable module 152 within the holder body. The cable module 152 can be retractable or non-retractable and can include a connection cable to transfer an audio signal, a video signal, or a combined audio and video signal. In an embodiment employing a retractable cable, the cable is movable between an extended position and a retracted position. A portion of the retractable cable is extended outside of the holder body in the extended position but, preferably, not in the retracted position.

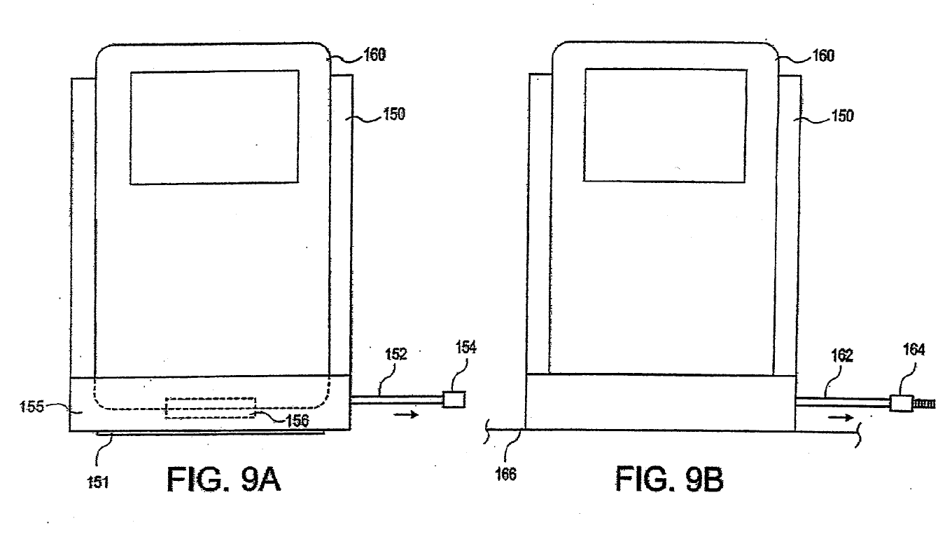

FIGS. 9A-9C illustrate an embodiment in which the holder 150 for a portable media unit 160 includes a holder body to receive the portable media unit 160. In the example of FIG. 9A, the holder 150 has a connector 156 to receive a connection on the bottom of the portable media unit 160. The connector 156 can include connections for audio signal transfer and power, for example. The cable module 152 can be retractable or non-retractable and can be used to transfer both an audio signal and power, for example, from the device with a speaker, to the holder 150 and thereby to the portable media unit 160 and vice versa. A plug 154 from the cable module 152 can then be connected to the device with a speaker to play music from the portable media unit 160 while providing power and recharging the portable media unit 160. In the example of FIG. 9A, a sticky pad 151 can be used to connect the holder 150 to a device. Other mechanisms including bolts and/or other fastening devices can be used to secure the holder 150 to, for example, a housing of a device with a speaker. Alternatively, the holder 150 can be a part of the device, thereby eliminating the need to affix the holder 150 to the device. Further it is to be understood that a base 155 can be weighted to allow the holder 150 to stand upright on a surface without the need to secure the holder 150 to the surface with a sticky pad 151, bolts or any other mechanism. In this case, a sticky pad 151 or other securing mechanism of the holder 150 could be removed as desired. The examples shown in FIGS. 9A-9C show a backrest on the holder 150 for the portable media unit 160. The backrest is optional. The cable module 152 can be positioned in the base 155 of the holder 150. The cable module 152 can be removed from the holder 150 for servicing. In the embodiment in which a retractable cable is employed, when the plug is pushed on when the retractable cable is in the retracted position, a mechanism releases some of the cable so that the cable can be easily removed. The retraction mechanism depicted in FIG. 3 can be used in the embodiment of FIG. 9A to store and selectively deploy the cable module 152. In one embodiment, the connection cable is used for connecting to a device with a speaker.

As shown in FIG. 9B, in one embodiment, the holder 150 can be part of a device 166 with a speaker. In this embodiment, the cable module can provide a stereo cable 162 and plug 164 for connecting to a jack on the portable media unit 160. The device 166 can include one or more speakers to play music from the portable media unit 160. The cable 162 can be retractable or non-retractable.

FIG. 9C illustrates an embodiment in which the holder 150 has a second connection cable 174. The second connection cable 174 can be connected to the speaker output jack of the portable media unit 160. The signal can then go through the retractable cable module 170 to plug 172 which can be connected to a device with a speaker. In one embodiment, the second connection cable 174 does not retract. In another embodiment, the second connection cable 174 can retract. In this embodiment, the retractable cable module can be a dual retraction unit.

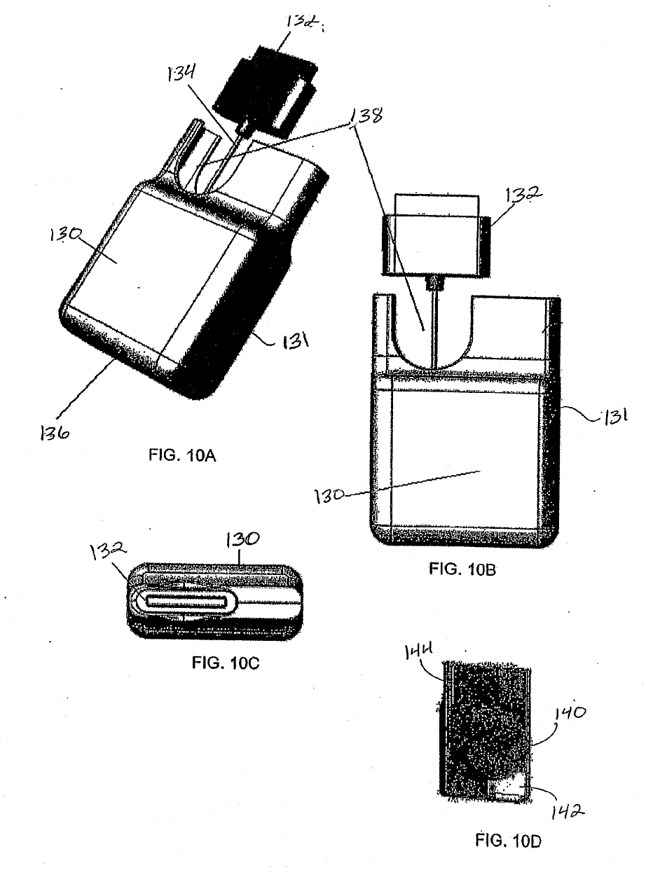

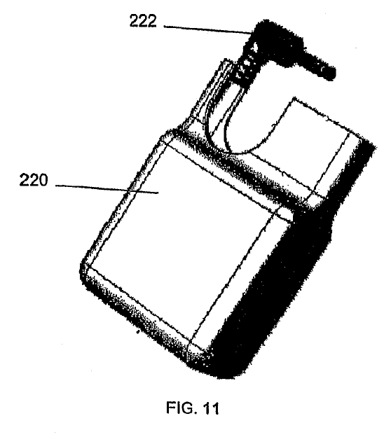

FIGS. 10A-C show a cable module 130 with a connector 132 attached to a cable 134. The cable 134 can be wound about a spool and kept under tension as discussed above. A connector 136 at the bottom of the cable module 130 can allow for the connection of the cable module 130 to another device, such as a chair device, a media player, or stereo speakers. The cable module 130 can have a removal slot 138 to allow the connector 132 to be grasped by a user. A digital or analog media signal, such as a music signal, can be sent from the portable media unit through the connector 132 to the device. In this embodiment the cable 134 is retractable. In an alternative embodiment the cable 134 can be non-retractable and of a fixed length.

In one embodiment, the connector 132 can also be adapted to provide power to the portable media unit. The 32-pin connector used with the iPod® is an example of a connector that can be used for both a power transfer to the portable media unit and to obtain an audio signal from the portable media unit. The 32-pin connector of the iPod® includes left/right analog audio input, left/right analog audio output, USB connection pins, Firewire connection pins, a device id pin and a power pin. The relevant pins can be electrically connected through the connector 136 of the cable module 130 to the device.

The module can have an interface with other types of portable media players to allow power to be input and audio or video or other signals to be output. Other modules, such as CD, tape or DVD player modules, radio modules and the like, can be substituted for the module with an appropriate portable media unit connector. Such connectors can include an iPod® connector as described above, an iPod® Shuffle connector, a thick wired iPod® connector that allows remote control use of the portable media unit and that can charge the portable media unit, or the like.

The cable module 130 can include a housing 131, a cable 134 located in the housing 131, a portable media unit connector 132 mounted on the end of the cable 134, and a port located on a sidewall of the housing 131. The connector 132 can have a received position relative to the port when the cable 134 is retracted in the housing 131. In an alternative embodiment, the cable 134 can be non-retractable and of a fixed length. In either case, the connector 132 can be accessible at the top of the housing 131. The connector 132 can be located adjacent to the sidewall and the port and adapted such that a user may reach through the port in the sidewall in order to pull the connector 132 out of the housing 131.

The housing 131 can have a main body and a neck extending from the main body. The sidewall can be provided in the neck. A port can be provided in the neck. Another port can be provided through the neck and can be at least partially aligned with the port to allow a user to access the connector 132 through the port and the other port. The two ports can form the access area/removal slot 138.

In one embodiment, the housing 131 can include a rectangular main body and a rectangular neck extending from the main body. The neck can be thinner than the main body.

In yet another embodiment, another connector 136 can be provided in the housing 131. The other connector 136 can communicate with the cable 134, whether the cable 134 is retractable or non-retractable. The other connector 136 can be affixed to the housing. The other connector 136 can be provided on a portion of the housing 131 that is opposite to the neck.

In one embodiment, the housing 131 can include a top and a bottom, a cable 134 located in the housing, and a portable media unit connector 132 mounted on the end of the cable 134. The connector 132 can be accessible at the top of the housing 131. Another connector 136 can be accessible at the bottom of the housing 131. In one embodiment, the other connector 136 is affixed to the bottom of the housing 131.

FIG. 10D shows a cross-sectional view of a cable module 130 showing a tensioning spool 140 connected to a module connector 142 to create a retractable cable module. The tensioning spool 140 can be used for winding out the 32-pin connector 144.

FIG. 11 shows a module 220 with a jack connector 222. The module 220 with the jack connector 222 can replace the cable module 130 in the device with a speaker. The jack connector 222 can transfer a stereo audio signal. Although FIG. 11 illustrates a module 220 with a retractable cable, it should be understood that the cable can alternatively be non-retractable and of a fixed length.

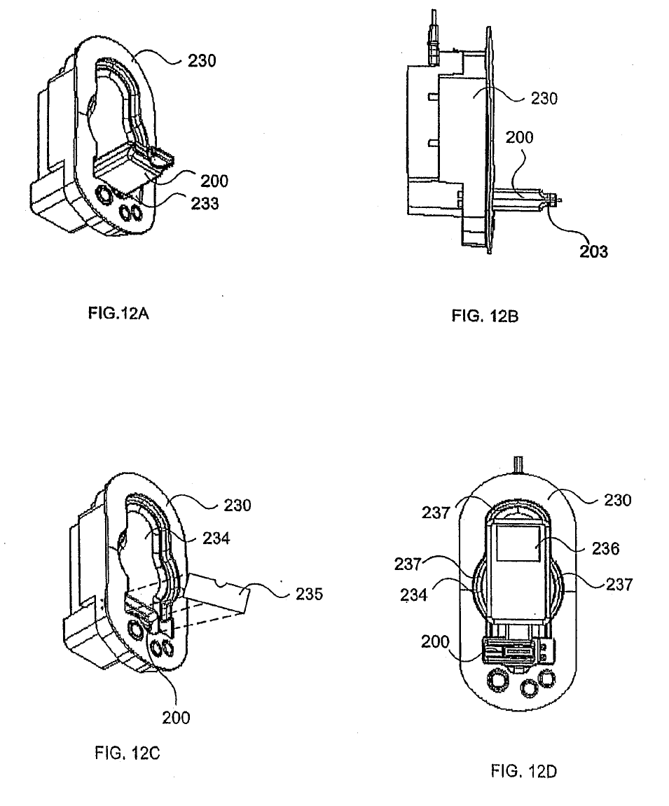

FIGS. 12A and 12B illustrate a holder 230 which can receive an interchangeable cable module 200. FIG. 12C shows that the cable module 200 can be positioned within the holder 230. The cable module 200 can be received in a recess 233 of the holder 230. The recess 233 in this embodiment is rectangular to accommodate the shape of the cable module 200. It should be understood that the shape of the cable module 200 and the shape of the recess 233 are not limited to rectangular, but can be any shape so long as the recess 233 is shaped to receive the cable module 200. The cable module 200 can be placed in and removed from the recess 233 by the user gripping the edge 203 of the cable module 200 (FIG. 12B). Alternately, the recess 233 can be provided with a spring loaded device for receiving and ejecting the cable module 200. As is known in the art, the cable module 200 can be inserted into the recess 233 with the spring loaded device. Subsequent pushing down on the cable module 200 can cause a spring of the spring loaded device to urge the cable module 200 upward and out of the recess 233 of the holder 230.

The holder 230 can be part of a chair or other piece of furniture or equipment such as a speaker system. The holder 230 can include another recess 234 for receiving a portable media unit. This additional recess 234 can include a site 237 for finger access that allows a user to grip the portable media unit when it is being inserted into or pulled out of the recess 234.

FIG. 12D illustrates a portable media unit 236 positioned within the recess 234 of the holder 230. The portable media unit 236 can be connected to the cable module 200 using a connector such as those described in relation to FIGS. 10A-10D and FIG. 11. A protective cover 235 such as shown in FIG. 12C can be selectively placed over the outside of the top portion of the cable module 200 and affixed to the holder 230. The protective cover 235 can be a flat element with a finger access region for removal. Alternately, the protective cover 235 can be a flat element with a center hole for surrounding the top portion of the cable module 200.

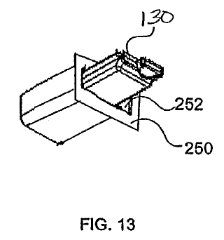

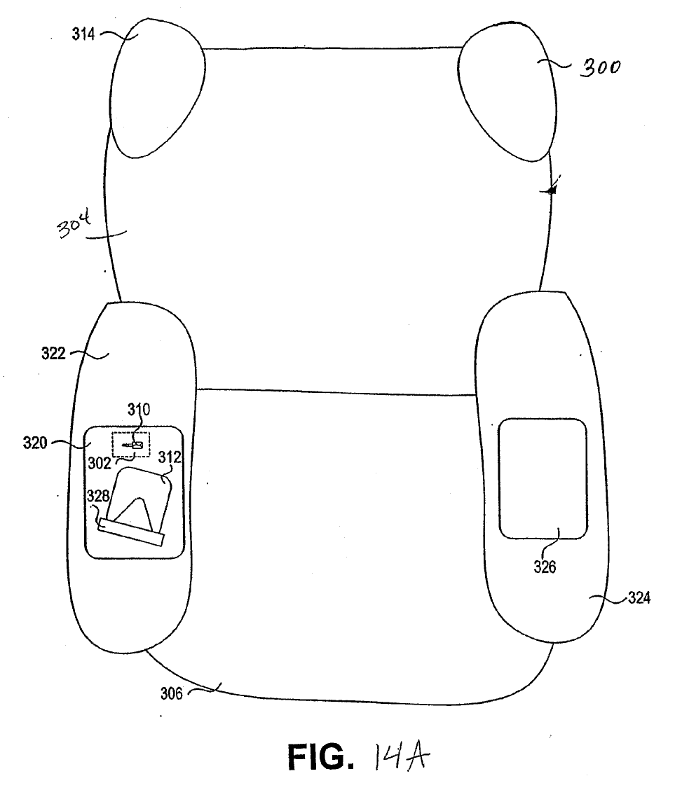

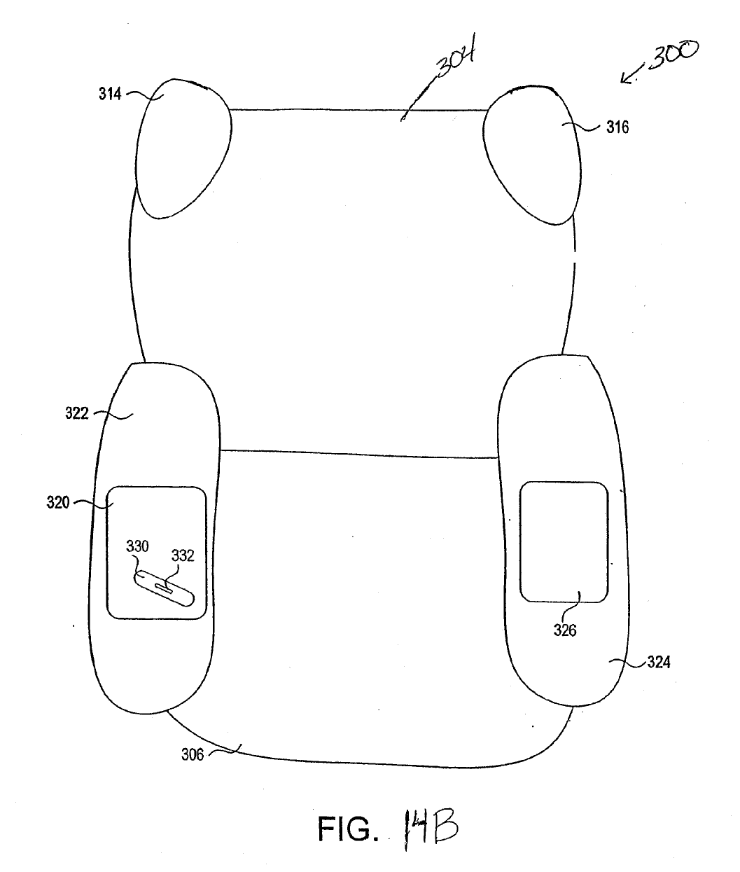

FIG. 13 shows an alternate embodiment of a holder 250 without a region to hold a portable media unit. This holder 250 has a recess 252 that can operate similar to recess 233 of FIG. 12A.

Referring back to FIGS. 12A-12D, another embodiment of the present invention is a device adapted for receiving a portable media unit 236. The device can include a first compartment 234 adapted to receive a portable media unit 236 and a second compartment 233 adapted to receive a cable module 200 that contains a connector (such as those described in relation to FIGS. 10A-10D and FIG. 11) that can connect to the portable media unit 236. The second compartment 233 can include a connector adapted to connect to the cable module 200.

The second compartment 233 can be provided at about 90 degrees from the first compartment. The first compartment 234 can be horizontal, and the second compartment 233 can be vertical. The first compartment 234 can be shallow and the second compartment 233 deep.

The second compartment 233 can include an ejection mechanism that is adapted to eject a cable module 200 positioned in the second compartment 233. The connector (such as those described in relation to FIGS. 10A-10D and FIG. 11) can be located at the bottom of the second compartment 233. A protective cover 235 can enclose the second compartment 233.

The first compartment 234 can include at least one finger recess 237 adapted to accept at least one finger of a user to aid in removing a portable media unit 236 from the first compartment 234. The second compartment 233 can include at least one finger recess adapted to accept at least one finger of a user to aid in removing a cable module 200 from the second compartment 233.

FIGS. 14A and 14B illustrate a chair 300 with a retractable cable module 302. In one embodiment, the chair 300 includes a back portion 304; a seat portion 306; and a retractable cable module 302. The retractable cable module 302 can include a connection cable (not shown) with a plug 310 adapted to be connected to a portable media unit 312 to provide an audio signal to the chair 300, wherein the connection cable is movable between an extended position and a retracted position, and wherein a portion of the connection cable is extended outside of the retractable cable module 302 in the extended position. The portable media unit 312 can be an MP3 player, a portable video player, a portable music player, or the like.

In one embodiment, the chair 300 has one or more speakers 314 and 316, and the audio signal is provided to the speakers 314 and 316. As shown in FIGS. 14A and 14B, the speakers 314 and 316 can be located in the back portion 304 of the chair 300.

The chair 300 can be a massage chair. The audio signal can be sent to the massage chair to control a massage. For example, the massage chair can vibrate at a rate corresponding to the base portion of the audio signal.

The retractable cable module 302 can be located in a console 320. In one example, the console 320 is located in one of the armrests 322. In the example of FIGS. 14A and 14B, the other armrest 324 includes another console 326.

The retractable cable module 302 can be removable. For example, the retractable cable module 302 can be screwed onto the chair 300. The retractable cable module 302 can have another plug on the connection cable (such as the plug 110 shown in FIGS. 3, 4, and 6A) to operably connect the connection cable to the chair 300. The chair 300 can have at least one door to allow for access to the retractable cable module 302.

Similar to FIGS. 3 and 4, the retractable cable module 302 can include a spool on which a section of the connection cable is wrapped in the retracted position and a tensioning spring. The tensioning spring can be used to wind up the connection cable on the spool. The retractable cable module 302 can also include a ratchet to hold the connection cable in the extended position.

The plug 310 can be a stereo plug, for example. The chair 300 can include a holder 328 adapted for receiving a portable media unit 312. The chair 300 can auto detect when the plug 310 is connected to the portable media unit 312. The chair 300 can have an audio source within the housing. Similar to FIG. 6B, the chair 300 can include a port or slot that can removably receive the retractable cable module 302.

FIG. 14B illustrates a chair 300 with a mount 330 adapted to receive a portable media unit 312, wherein the mount 330 includes a connector 332 adapted to receive an audio signal from the portable media unit 312 when the portable media unit 312 is connected to the mount 330.

The mount 330 can be a recess in the console 320 that can receive a portable media unit 312. The connector 332 can be fixed within the mount 330 to connect with a connector on the portable media unit 312 when the portable media unit 312 is connected to the mount 330.

In one embodiment, the connector 332 can also be adapted to provide power to the portable media unit 312. The 32-pin port connector used with iPods® is an example of such a connector that can provide both power and an audio signal. The chair 300 can include a wall socket plug and a transformer to provide the power to the portable media unit 312.

In one embodiment, the chair 300 can have a holder adapted for a portable media unit. The chair 300 can have an additional audio source if desired.

FIG. 15 illustrates a chair 400 with a port connector for a portable media unit. The chair 400 can comprise a seat portion 402 and a mount 404 adapted to receive a portable media unit. The mount 404 can include a connector 406 adapted to receive an audio signal from the portable media unit.

The mount 404 can be a recess in the console 408 that can receive a portable media unit. The connector 406 can be fixed within the mount 404 to connect with a connector on the portable media unit. In one embodiment, the recess is sized to fit a portable media unit, such as an iPod®, and an insert can be placed in the recess to fit smaller sized devices, such as an iPod® Mini.

In one embodiment, the connector 406 can also be adapted to provide power to the portable media unit. The 32-pin port connector used with the iPod® is an example of a connector that can be used for both a power transfer to the portable media unit and to obtain an audio signal from the portable media unit. The 32-pin port connector of the iPod® includes left/right analog audio input, left/right analog audio output, USB connection pins, Firewire connection pins, a device id pin and a power pin. The iPod® has other connections for a controller and for earphones. The chair 400 can include a wall socket plug and a transformer to provide DC power to the portable media unit.

In one embodiment, the connector 406 can be a part of a removable module. The module can have an interface with the remainder of the chair 400 to allow power to be input and audio or other signals to be output. Other modules, such as a CD, tape or DVD player modules, radio modules and the like, can be substituted for the module with a portable media unit connector.

The chair 400 can have a holder adapted for a portable media unit. The chair 400 can have an additional audio source, such as a radio, CD player or the like.

The chair 400 can have one or more speakers 410 and 412. The audio signal can be provided to at least one of the speakers 410 and 412 to play music or other audio. The speakers 410 and 412 can be in a back portion 414 of the chair 400 adjacent to the user's ears. The chair 400 can also have additional speaker elements, such as a sub-woofer, within the body of the chair 400. A sub-woofer can play a low-frequency portion of the audio signal.

The chair 400 can be a massage chair. A massage chair can use the audio signal to control a massage. For example, the massage chair can vibrate at a rate corresponding to a base portion of the audio signal. An analog or digital lowpass filter can be used to obtain the base portion of the audio signal to control the vibration.

The portable media unit can be any portable unit including an MP3 player, a radio, a Compact Disk (CD) player or a video player, such as a portable digital video player that stores digital video files. An audio component of the video signal can be played through at least one of the speakers 410 and 412. The portable media unit can include memory, such as a hard disk and/or flash memory, a processor, operating software, display screens, connectors, input elements, speakers and/or ear phones.

The chair 400 can provide standard connections to other electronics including network connections (e.g., Ethernet connections, USB, or Firewire connections). The chair 400 can connect to electronics, computers, televisions and other devices. FIG. 15 shows the chair 400 connected to a laptop computer 416.

The chair 400 can have an embedded processor or computer to handle audio signal processing, networking protocols and the like. Device connections can be to the consoles 408 or 409. The consoles 408 and 409 can include input and/or display elements as well. The chair 400 can have headphone jacks, and other stereo inputs and outputs.

FIG. 16 illustrates a chair 418 with a wireless connection unit 420 for connecting to a local unit 422 such as a portable media unit. A second wireless connection unit can be a part of or can be an add-on to the local unit 422. An add-on wireless connection unit can connect to a port connector on the local unit 422. In one embodiment, the chair 418 includes a seat portion 424 and a wireless connection unit 420 adapted to wirelessly receive an audio signal from local unit 422.

The wireless connection unit 420 can use a protocol such as a 802.11 protocol (including 802.11a and 802.11g protocols), a Bluetooth protocol or other wireless protocol (including other wireless network protocols). The chair 418 can include a processor internal or external to the wireless connection unit 420 to help implement the wireless protocol. The audio signal sent can include an uncompressed digitized analog signal or a compressed audio file such as an MP3. Digitized analog signals can be converted to an analog signal using a digital-to-analog (D/A) converter. Compressed files can be uncompressed in a processor and then converted into an analog signal.

In one embodiment, the chair 418 has one or more speakers 426 and 428, and the audio signal is provided to at least one of the speakers 426 and 428 to be played by the one or more of the speakers 426 and 428. In one embodiment, an analog audio signal derived from a transmitted digital audio signal is provided to at least one of the speakers 426 and 428. In the example of FIG. 16, the speakers 426 and 428 are in a back portion 430 of the chair 418.

The wireless connection unit 420 can be built into the chair 418. Alternately, the wireless connection unit 420 can be a wireless connection card adapted to connect to a port on the chair 418. Examples of wireless connection cards include PCMCIA cards that connect to a PCMCIA port on the chair 418.

The wireless connection unit 420 can include a transceiver to send information to the local unit 422. For example, the transceiver can send information related to the wireless link status to the local unit 422. The wireless connection unit 420 can be adapted to wirelessly transmit a control signal to the local unit 422 to control the selection of songs, for example.

The local unit 422 can be a portable media unit, such as a portable digital music player. In one embodiment, the local unit 422 can support a wireless protocol and use a wireless transceiver.

The local unit can interconnect with the chair in a number of ways. The local unit can dock to the chair for sending audio signals to the chair. The local unit can also wirelessly connect to the chair or a component attached to the chair while the local unit is docked or undocked.

The chair 418 can have a holder adapted for the local unit 422. In one embodiment, a mount 432 including a connector 434 can be adapted to receive an audio signal from a portable media unit. The mount 432 can be in an armrest 436. The mount 432 can be a recess in the console 438 that can receive a portable media unit. The connector 434 can be fixed within the mount 432 to connect with the connector on the portable media unit.

Other components 440 can wirelessly connect to the chair 418 through the wireless connection unit 420. The other components 440 can include a wireless headphone, a wireless controller, and/or a wireless display such as a wireless sunglass display. Alternately, the local unit 422 can wirelessly interconnect with the other components 440.

The chair 418 can also include a keyboard 442. The keyboard 442 can be used to input into and control the local unit 422, as well as for other functions. The keyboard 442 can be built into the chair 418. In one embodiment, the keyboard 442 can fold out of the armrest 441. The keyboard 442 can also be a detachable or independent keyboard 442. The chair 418 can also include a display 444.

FIG. 17 illustrates an example where a local unit 446 wirelessly connects to components associated with the chair 447. In this example, removable speakers 448 and 450 are provided. The local unit 446 can wirelessly connect to wireless connection unit 452 associated with speaker 448 and to wireless connection unit 454 associated with speaker 450. The local unit 446 can also wirelessly interconnect with a removable massage unit (not shown).

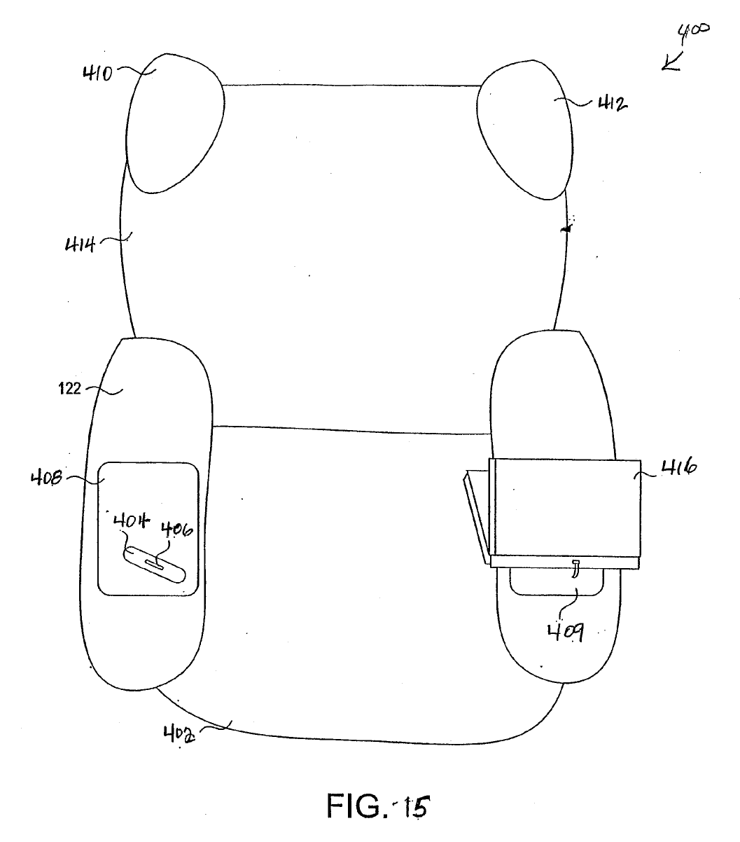

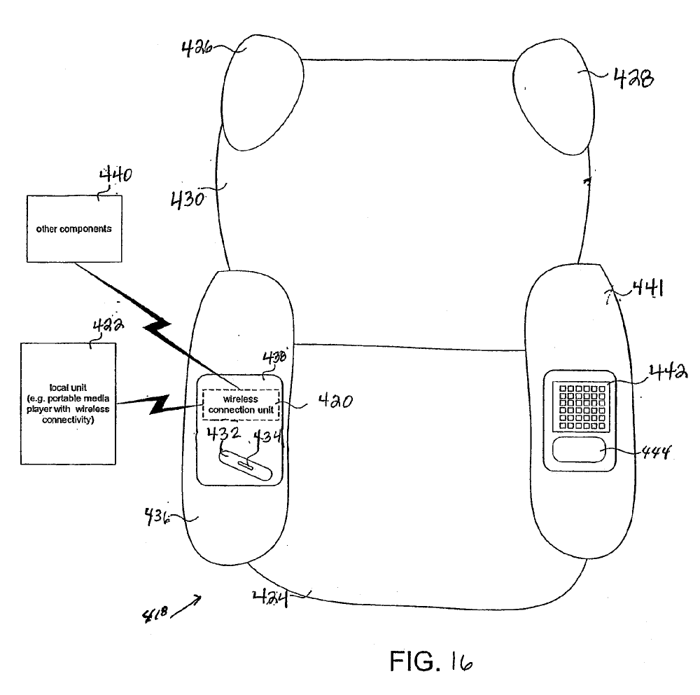

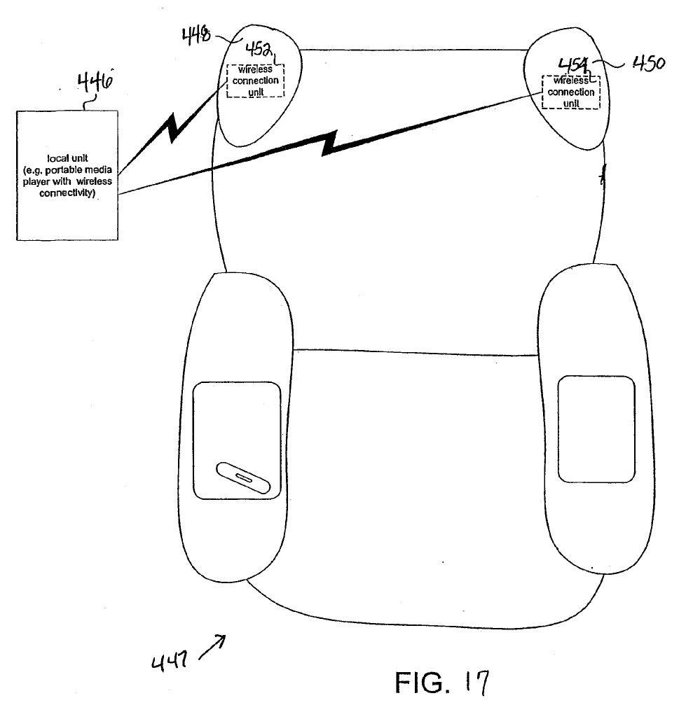

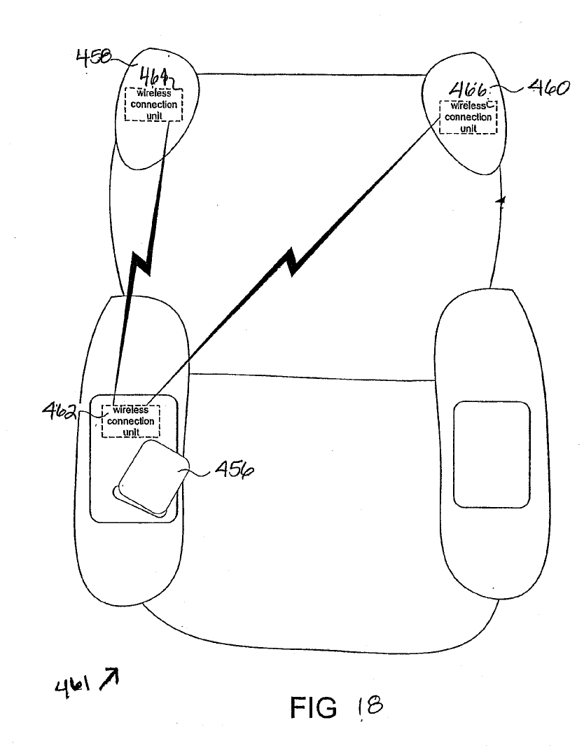

FIG. 18 shows an example of a docked local unit 456 that is wirelessly interconnected to removable speakers 458 and 460. The docked local unit 456, or wireless connection unit 462 in another portion of the chair 461, can wirelessly connect to wireless connection unit 464 associated with speaker 458 and to wireless connection unit 466 associated with speaker 460.

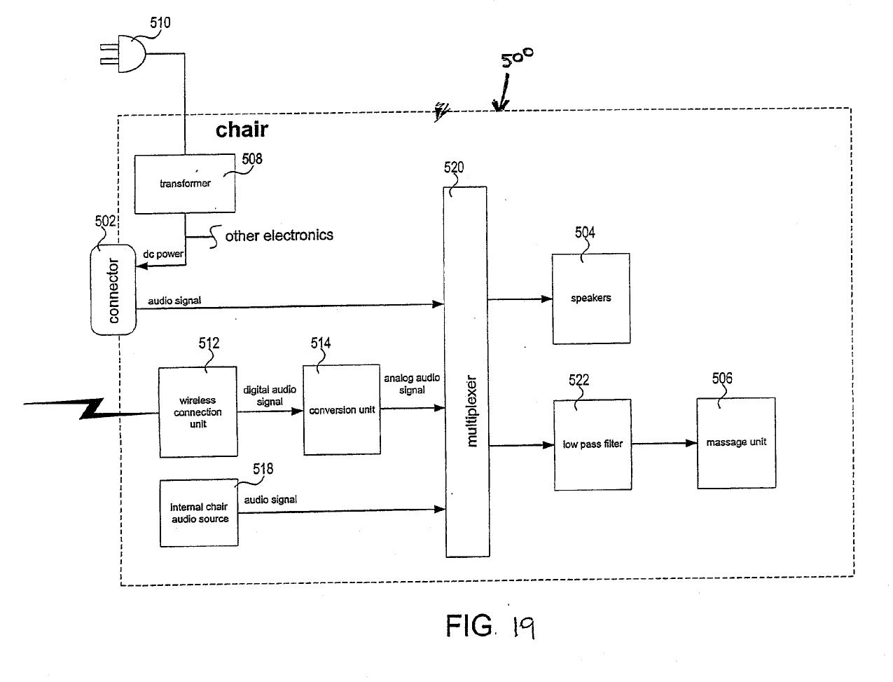

FIG. 19 illustrates a functional diagram of one embodiment. In the example of FIG. 19, the chair 500 includes a connector 502. In this example, the connector 502 can be used to provide power to a portable media unit as well as to send an audio signal from the portable media unit to speakers 504 or massage unit 506. In one embodiment, the transformer 508 is used to convert the AC power from plug 510 into DC power provided to the connector 502 as well as to the remainder of the electronics of the chair 500. The wireless connection unit 512 can be used to obtain an audio signal to be transferred from a local unit, such as a portable media unit, using a wireless protocol. In one embodiment, a digital audio signal is converted into an analog signal in conversion unit 514, which can include hardware and/or software elements. In one embodiment, the conversion unit 514 can decompress an MP3 file or other compressed audio files. In addition, internal chair audio source 518, such as a radio, CD player or the like, can also be used. A multiplexer 520 can be used to select between the different audio sources. The multiplexer 520 can be implemented in hardware and/or software. In one embodiment, audio signals can be sent to speakers 504 and/or to the massage unit 506. In one embodiment, a low pass filter 522 is used to obtain a base (low frequency) portion of the audio signal for massage unit 506. In one embodiment, the massage unit 506 vibrates in accordance with the audio signal. The control of the massage can be done in software as well.

In one embodiment, the chair 500 can include user input to control elements such as the loudness of the speakers 504, the operation of the massage unit 506 and the selection of the audio source. In one embodiment, the audio source can be auto-selected. In one example, when a portable media unit is connected to connector 502, the audio signal from the portable media unit will be automatically selected for the speakers 504 or the massage unit 506.

The example of FIG. 19 illustrates inputs from the connector 502 and wireless connection unit 512, as well as outputs to speakers 504 and massage unit 506. Any combination of these inputs and outputs can be used with the chair 500.

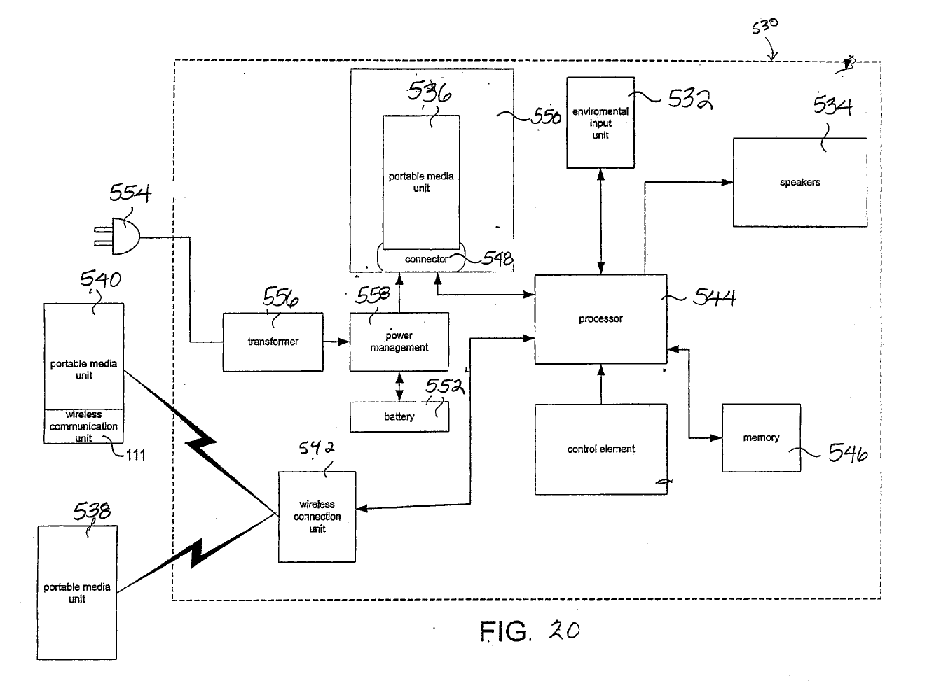

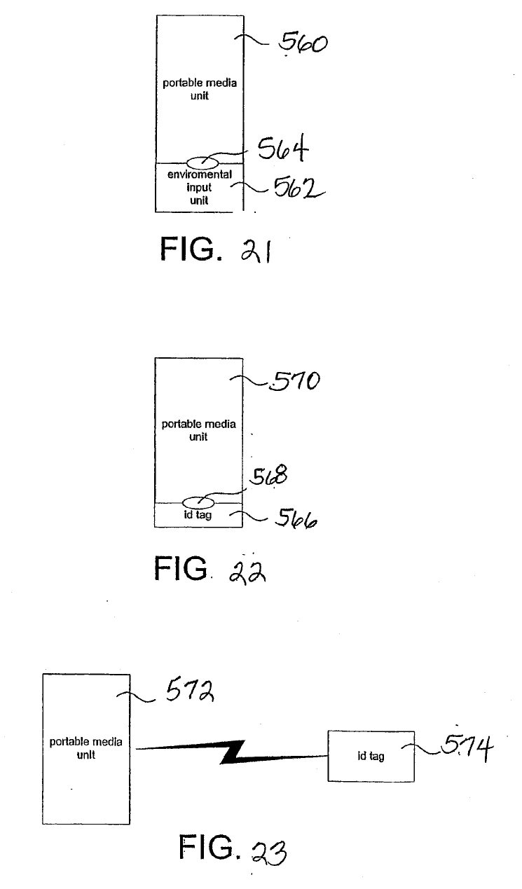

FIG. 20 illustrates a case in which a device 530 includes an environmental input unit 532. The environmental input unit 532 can be a weather monitor, thermometer, a clock or the like. In the embodiment of FIG. 20, the device 530 includes speakers 534 to play audio signals from the portable media unit 536, 538, or 540. In this example, the portable media unit 538 can wirelessly connect to a wireless connection unit 542.

The wireless connection unit can use a protocol such as a 802.11 protocol (including 802.11a and 802.11g protocols), a Bluetooth protocol and/or other wireless protocol (including other wireless network protocols). The devices can include a processor internal or external to the wireless connection unit to help implement the wireless protocol.

The wireless connection unit can be a part of the device 530. Alternately, the wireless connection unit can be a wireless connection card adapted to connect to a waterproof port on the portable video player. Examples of wireless connection cards include PCMCIA cards that connect to a PCMCIA port.

The wireless connection unit can include a transceiver to send information to the local unit. For example, the transceiver can send information related to the wireless link status to the portable connection unit.

The audio files can be sent from the wireless connection unit 542 to processor 544 to be sent to the speakers 534. Processor 544 can be associated with the memory 546. The device 530 can include a control element for selecting a song on one of the portable media units 536, 538 or 540. The device 530 can also include a connector 548 for connecting to a portable media unit 536. The connector 548 can be part of a mount 550.

In one embodiment, the connector 548 can also be adapted to provide power to the portable media unit 536. The 32-pin port connector used with the iPod® is an example of a connector that can be used for both a power transfer to the portable media unit and to obtain an audio signal from the portable media unit. The 32-pin port connector of the iPod® includes left/right analog audio input, left/right analog audio output, USB connection pins, Firewire connection pins, a device id pin and a power pin. The connector can be adapted to provide power to the portable media unit 536. The portable media unit 536 can include both a wireless connection unit and a connector.

In one embodiment, the connector 548 can be a part of a removable module. The module can have an interface with the remainder of the device 530 to allow power to be input and audio or other signals to be output. Other modules, such as CD, tape or DVD player modules, radio modules and the like, can be substituted for the module with a portable media unit connector.

Power from the device 530 can be provided through the connector 548 to the portable media unit 536. This power can be from the battery 552 or from an AC plug 554. In one embodiment, the AC power is sent to the transformer 556 and converted to DC power which is sent to the power management unit 558. The DC power can be provided to the electronics of the device 530 including to the connector 548 for charging up a battery of the portable media unit 536. The power can also be provided to recharge the battery 552 of device 530. Power from the battery 552 can also be sent to the power management unit 558 and then to the connector 548 and to the rest of the electronics of the device 530.

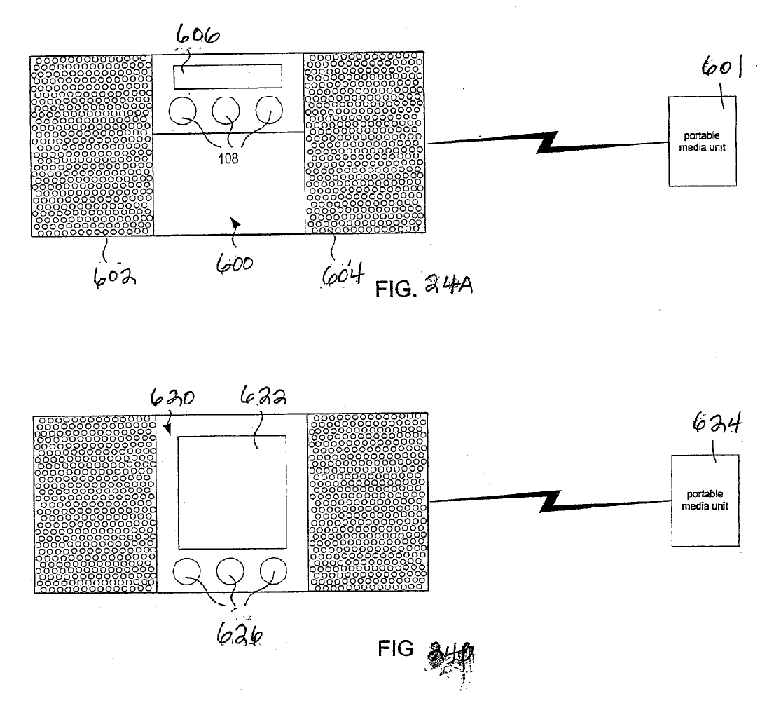

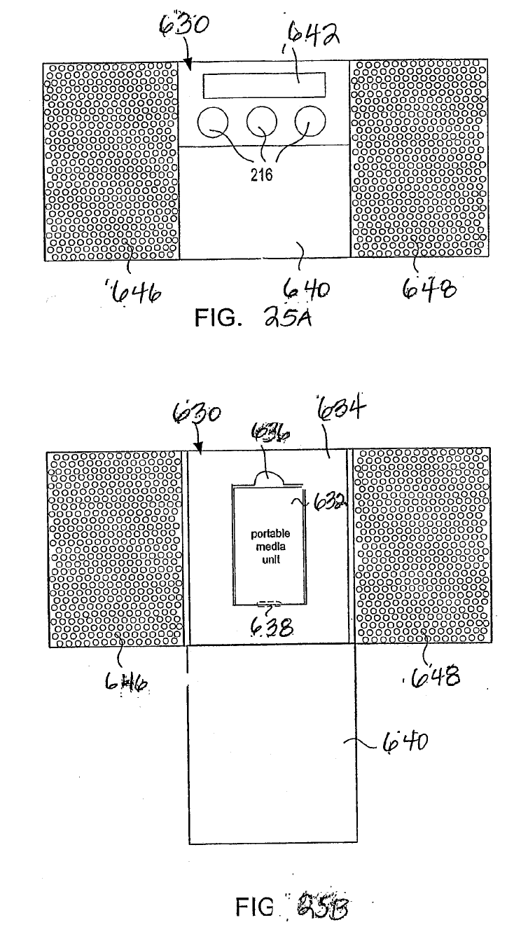

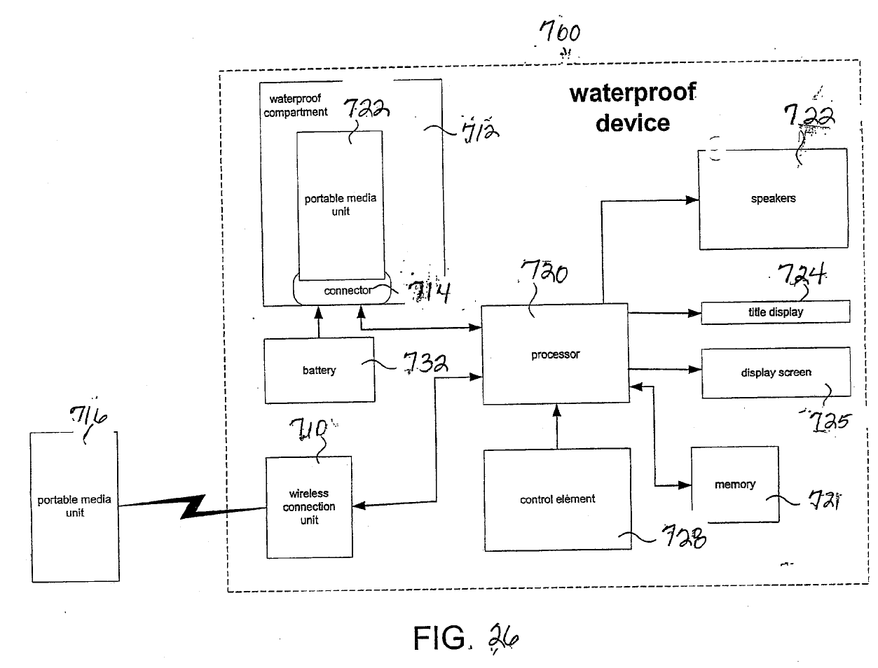

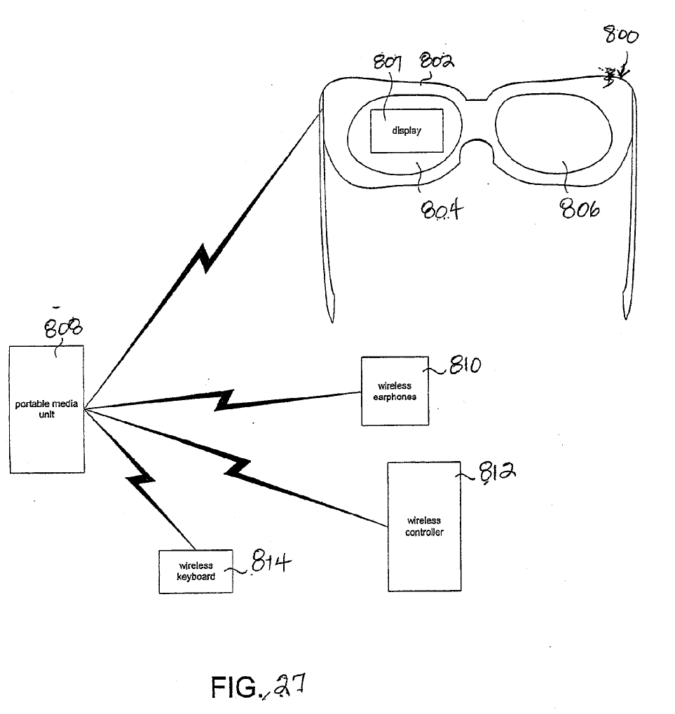

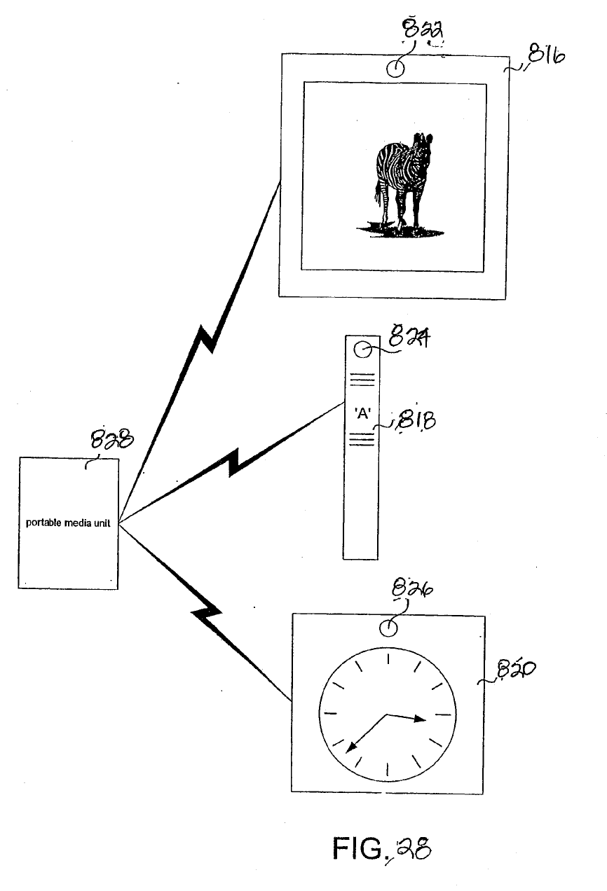

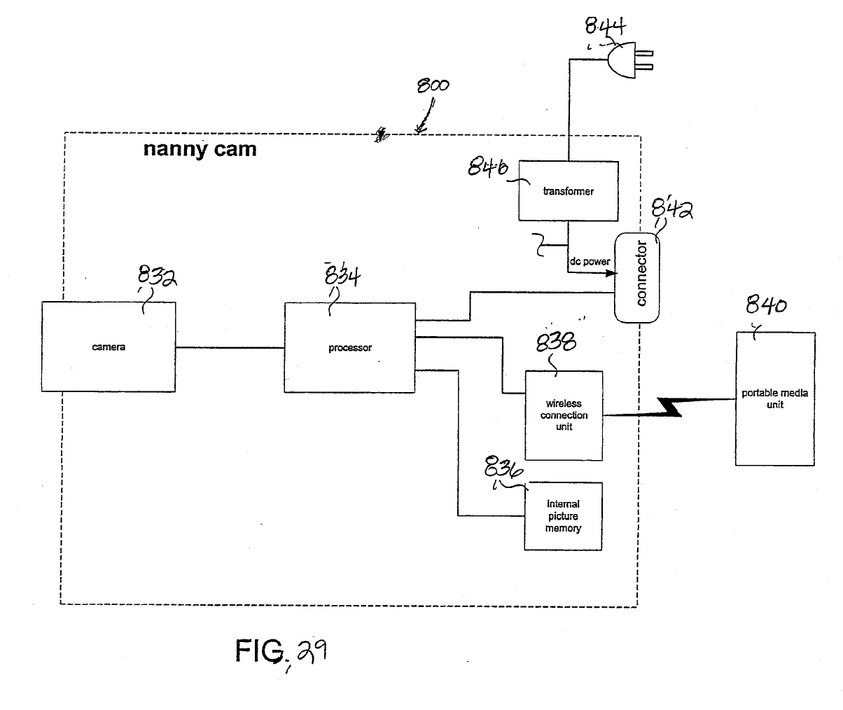

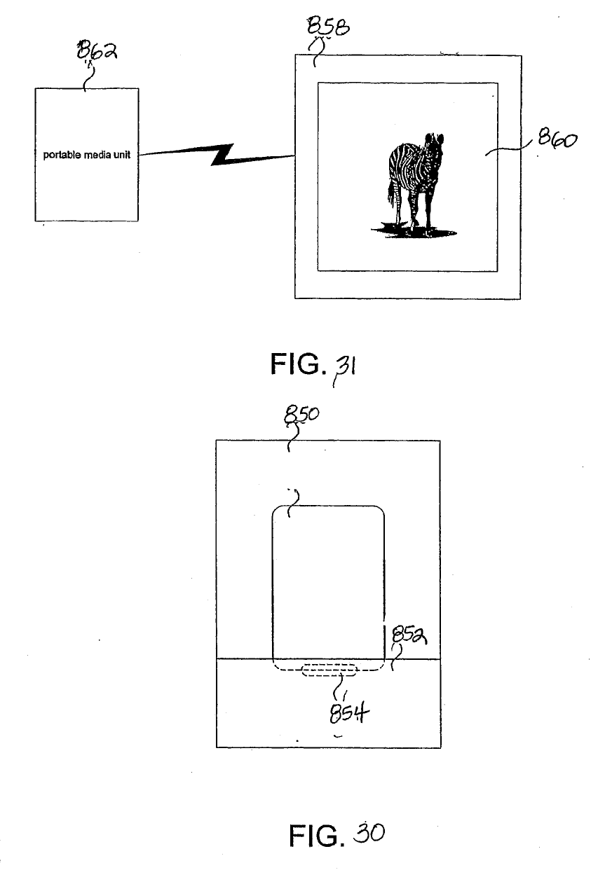

FIG. 21 illustrates an embodiment in which the portable media unit 560 connects to an environmental input unit 562. The environment input unit 562 can be a clock, thermometer, or weather monitor or other unit. The environmental input can be transferred across the connector 564 to the portable media unit 560 to affect the operation of the portable media unit 560.

In one embodiment, a personal ID unit identifies a user to a portable media unit which then automatically personalizes the display of a portable media unit based on the user.

In one embodiment the portable media unit is an MP3 player, such as an iPod® or iPod® Mini. As shown in FIG. 23, the personal ID unit 566 can attach to a connector 568 on the portable media unit 570.

The displays can include playlists of the user, which can be displayed based on the user ID. For example, in one embodiment, each user can have a variety of playlists, each playlist can be only available to that user or the playlist of the user can be given some priority in the display of the personal media unit.

FIG. 23 illustrates an example where a portable media unit 572 interrogates a personal ID unit 574 wirelessly. The portable media unit 572 can interrogate using an RFID system or using some other wireless system. For example, users can have RFID tags and the RFID tags can affect the display of the portable media unit 572. The personal ID unit 574 can be a passive device without a battery or an active device with a battery.

FIG. 24A illustrates a waterproof device 600 wirelessly connected to a portable media unit 601. The waterproof device 600 includes waterproof speakers 602 and 604. The speakers 602 and 604 can be waterproofed by using a plastic or other type of coating on the outside of the speakers 602 and 604. The waterproof device 600 can include a display 606 for displaying the titles of the media to be played and control elements 608. The waterproof device 600 can include additional audio sources such as a radio, CD Player or the like. Title display 606 and control elements 608 can be used for controlling the additional audio source as well as controlling the selection of media from the portable media unit 601. In one embodiment, the portable media unit 601 is an MP3 player and the control elements 608 can be used to select a song from the portable media unit 601. The title of the songs to be played can be displayed in the title display 606.

The portable media unit 601 can be any portable unit including an MP3 player, a radio, a Compact Disk (CD) player or a video player, such as a portable digital video player that stores digital video files. The portable media unit 601 can include memory, such as a hard disk and or flash memory, a processor, operating software, display screens, connectors, input elements, and speakers and/or earphones.

The wireless connection unit can use a protocol such as a 802.11 protocol (including 802.11a and 802.11g protocols), a Bluetooth protocol and/or other wireless protocols (including other wireless network protocols). The waterproof device 600 can include a processor internal or external to the wireless connection unit to help implement the wireless protocol.

The wireless connection unit can be built into the waterproof device 600. Alternately, the wireless connection unit can be a wireless connection card adapted to connect to a waterproof port on the waterproof device port. Examples of wireless connection cards include PCMCIA cards that connect to a PCMCIA port.

The wireless connection unit can include a transceiver to send information to the local unit. For example, the transceiver can send information related to the wireless link status to the portable connection unit.

The waterproof device 600 can include a mount. The mount can be suction cup mount, screw mount, hook mounts for hooking onto a shower nozzle or any other type of mount.

FIG. 24B illustrates an embodiment with a waterproof device 620 including a display screen 622. The display screen 622 can show video presentation. The portable media unit 624 can transfer video files to the waterproof device 620.

A second wireless connection unit can be a part of or can be an add-on to the portable media unit 624. An add-on wireless connection unit can connect to a port connector on the portable media unit 624. The control elements 626 can be used to select the video to be displayed on the display screen 622.

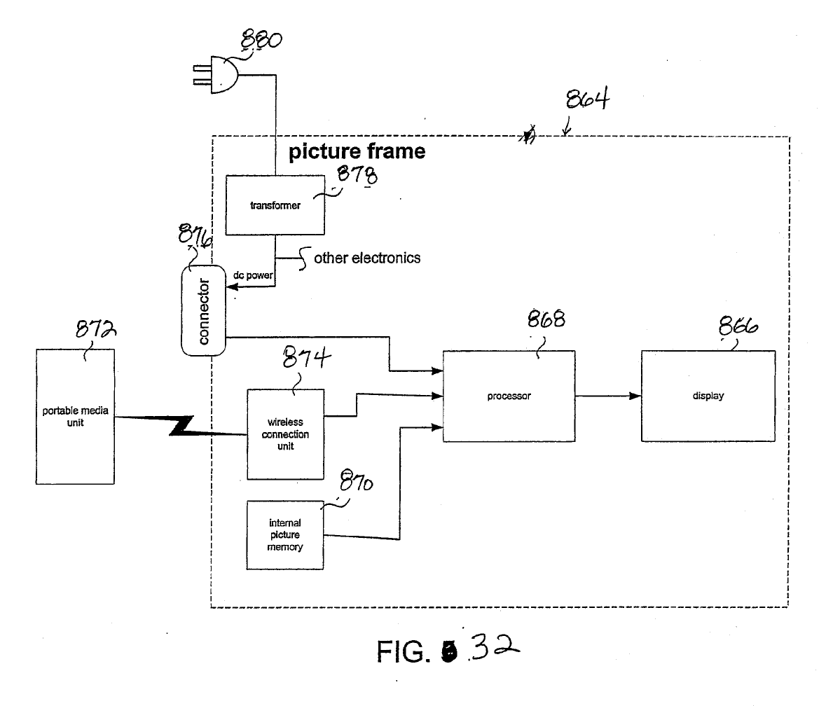

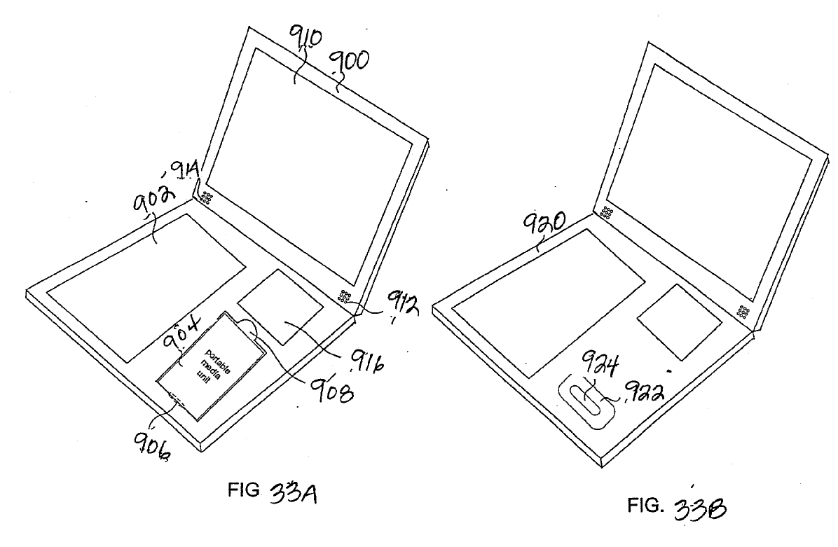

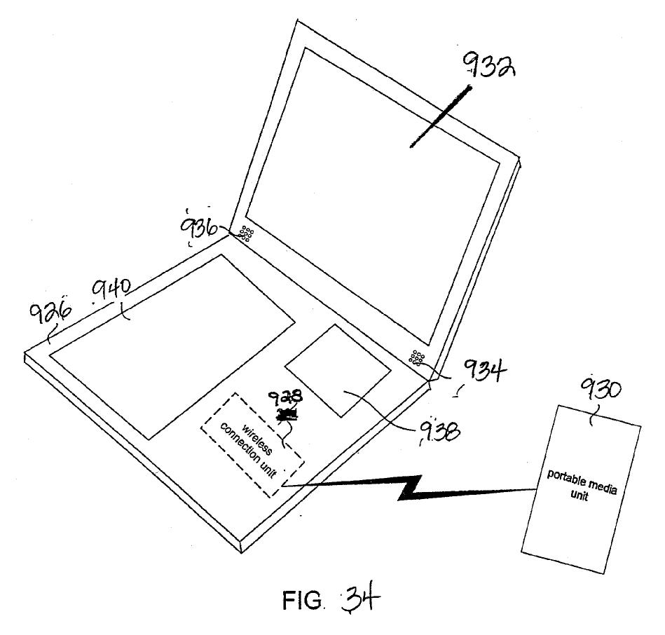

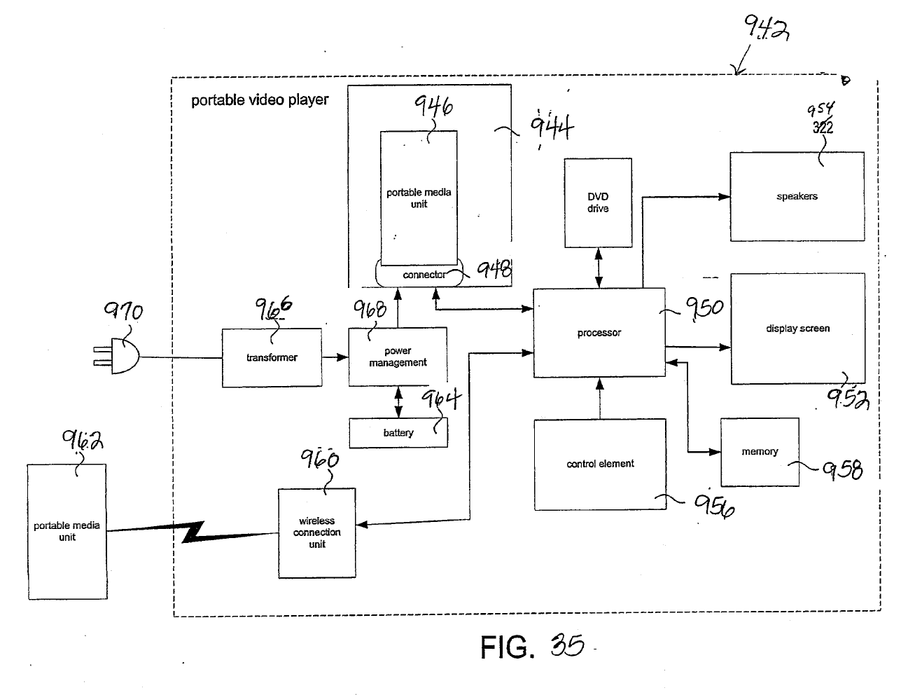

Referring to FIGS. 25A and 25B, one embodiment of the present invention is a waterproof device 630 including waterproof speakers and an internal waterproof compartment for containing a portable media unit 632. The compartment includes a connector adapted to transfer audio signals from the portable media unit 632.

FIGS. 25A and 25B illustrate an example in which an internal waterproof compartment is used to store the portable media unit 632. The waterproof device 630 includes a compartment 634 which has a recess 636 sized to fit the portable media unit 632. The compartment 634 also includes a connector 638 for connecting to the portable media unit 622. In one embodiment, the compartment 634 has a waterproof door 640 which can include the display 642 and the control elements 644. In an embodiment that has a screen display, the screen display can be placed on the waterproof door 640 as well. The waterproof device 630 can also include speakers 646 and 648.

A compartment 634 in the waterproof device 630 can receive the portable media unit 632. The connector 638 can be fixed within a recess 636 in the compartment 634 to connect with a connector on the portable media unit 632. In one embodiment, the recess 636 is sized to fit a portable media unit 632, such as an iPod®, and an insert can be placed in the recess 636 to fit smaller-sized devices, such as an iPod® Mini.

In one embodiment, the connector can be a part of a removable module. The module can have an interface with the remainder of the device to allow power to be input and audio or other signals to be output. Other modules, such as CD, tape or DVD player modules, radio modules and the like, can be substituted for the module with a portable media unit connector.

In one embodiment, the connector can also be adapted to provide power to the portable media unit 632. The 32-pin port connector used with the iPod® is an example of a connector that can be used for both a power transfer to the portable media unit 632 and to obtain an audio signal from the portable media unit 632. The 32-pin port connector of the iPod® includes left/right analog audio input, left/right analog audio output, USB connection pins, Firewire connection pins, a device id pin and a power pin. The connector can be adapted to provide power to the portable media unit 632. The weatherproof device 630 can include both a wireless connection unit and a connector 638.

FIG. 26 shows a functional diagram of a waterproof device 700. This waterproof device 700 shows both a wireless connection unit 710 and a waterproof compartment 712 with connector 714. Either the waterproof compartment 712 and/or the wireless connection unit 710 could be used to operably connect to a portable media unit 716. In one embodiment, the portable media unit 716 is used to wirelessly connect to the wireless connection unit 710. The media signal can be an audio signal, such as an MP3 file, or a wireless encoding of a media file. The media signal can be transferred to the processor 720 to be displayed on the speakers 722. The processor 720 can also get information from the portable media unit 716 to be displayed on the title display 724 or the video display screen 726. Control element input from the control element 728 can be used to select a song or other media. In one embodiment, the waterproof device 700 obtains a song list from the portable media unit 716 using the wireless connection unit 710 and then displays some or all of the song titles in the title display 724. The user can then select a song or other media to be played. The selection can be done using the control element 728. The processor 720 can have an associated memory 721 for buffering media and other storage of information. For example, the memory 721 can buffer a number of MP3s or other media files or information to later be played by the waterproof device 700.

In one embodiment, the waterproof compartment 712 includes a recess for storing a portable media unit 722. The portable media unit 707 can connect to the connector 714 for transferring audio files including media files such as MP3 files, video files and the like to the processor 720 for later display to the user. The connector 714 can be of the type that can power the portable media unit 722 using a battery 732.

Referring to FIG. 27, one embodiment of the present invention includes eyeglasses 800 having a frame 802, one or more lenses 804 and 806 in the frame 802 and a display unit 807. The eyeglasses 800 are adapted to wirelessly communicate with a portable media unit 808 to get media title information to display. The eyeglasses 800 can also include a wireless communication unit.

The wireless connection unit can use a protocol such as a 802.11 protocol (including 802.11a, and 802.11g protocols), a Bluetooth protocol and/or other wireless protocols (including other wireless network protocols). The eyeglasses 800 can include a processor internal or external to the wireless connection unit to help implement the wireless protocol.

The wireless connection unit can be a part of the eyeglasses 800. Alternately, the wireless connection unit can be a wireless connection card adapted to connect to a port on the eyeglasses 800. Examples of wireless connection cards include PCMCIA cards that connect to a PCMCIA port.

The wireless connection unit can include a transceiver to send information to the local unit. For example, the transceiver can send information related to the wireless link status to the portable connection unit.

A number of different types of display units 807 can be used. In one embodiment, the display unit 807 displays an image on a lens 804 or 806 of the eyeglasses 800. This type of projection can be of the type used in head-up displays in fighter jets, for example. The display unit 807 can project the display information from the outside or inside of the eyeglasses 800. In one embodiment, the display unit 807 is a screen display such as a flat panel display. The screen display can block one of the lenses 804 or 806. In another embodiment, the display unit 807 is part of the lens, such as lens 804 of the eyeglasses 800. The lens can include a display such as a liquid crystal display. In one embodiment, the display is such that the user can see through a lens while display information is displayed at the lens. In one embodiment, the eyeglasses 800 can be sunglasses with the lenses 804 and 806 being polarized lenses.

The portable media unit 808 can interact wirelessly with the eyeglasses 800. The portable media unit 808 can be associated with a wireless communication unit. The wireless communication unit can be built into the portable media unit 808, or an add-on wireless communication unit can connect to a connector of the portable media unit 808.

The connector in one embodiment is a 32-pin port connector used with an iPod®. The 32-pin port connector of the iPod® includes left/right analog audio input, left/right analog audio output, USB connection pins, Firewire connection pins, a device ID pin and a power pin. The connector can be adapted to provide power to the portable media unit 808. The portable media unit 808 can include both a wireless connection unit and a connector.

The portable media unit 808 can also interact with wireless earphones 810. The wireless earphones 810 can play audio signals from the portable media unit 808. In one embodiment, the wireless earphones 810 can be associated with the eyeglasses 800. The eyeglasses 800 can be used to both display information and to play the audio signals through associated earphones 810.

Additionally, a wireless controller 812 can be used. The wireless controller 812 can be used for controlling the portable media unit 808 including the selection of the songs, song list or other media, During the selection, the display unit 807 at the eyeglasses 800 can be updated with media title information. Additionally, a wireless keyboard 814 or other wireless input can be used to input information or otherwise control the portable media unit 808. The eyeglasses 800 can include an input, such as for a wireless controller 812.

In addition to the media title information, the display unit 807 of the eyeglasses 800 can also display media such as video files at the eyeglasses 800 using the same display unit 807 in one embodiment.

One embodiment of the present invention is a method. Media title information can be wirelessly received at eyeglasses 800 from a portable media unit 808. The media title information can then be displayed at the eyeglasses 800.

The system of the present invention can be used for mobile operation. The eyeglasses 800 can be worn to produce a hands-free display. The user can use the eyeglasses 800 to see the media title information while moving around. The wireless controller 812 can be placed at a number of locations such as at the belt in a backpack, or other locations. The wireless communication with the portable media unit 808 can allow the different elements of the wireless system to be stored in the enclosed backpacks and the like. Elements of the wireless controller 812 can be added to the eyeglasses 800 so that a button on the eyeglasses 800 can be used for selecting media to be played from the portable media unit 808.

Referring to FIG. 28, in one embodiment, a nanny cam 816, 818, and 820 can include a camera 822, 824, and 826 and a wireless connection unit adapted to send files to a portable media unit 828.

The portable media unit 828 can be any portable unit including an MP3 player, a radio, a Compact Disk (CD) player or a video player, such as a portable digital video player that stores digital video files. The portable media unit 828 can include memory, such as a hard disk and/or flash memory, a processor, operating software, display screens, connectors, input elements, and speaker and/or earphones.

The wireless connection unit can use a protocol such as a 802.11 protocol (including 802.11a, and 802.11g protocols), a Bluetooth protocol and/or other wireless protocols (including other wireless network protocols). The nanny cam 816, 818, and 820 can include a processor internal or external to the wireless connection unit to help implement the wireless protocol.

The wireless connection unit can be built into the nanny cam 816, 818, and 820. Alternately, the wireless connection unit can be a wireless connection card adapted to connect to a port on the nanny cam 816, 818, and 820. Examples of wireless connection cards include PCMCIA cards that connect to a PCMCIA port on the chair. A second wireless connection unit can be a part of or can be an add-on to the portable media unit 828. An add-on wireless connection unit can connect to a port connector on the portable media unit 828.

The wireless connection unit can include a transceiver to send information to the local unit. For example, the transceiver can send information related to the wireless link status to the portable connection unit.

The camera 822, 824, and 826 can be a video camera or still camera. The transferred files can be video or still picture files. In one embodiment, the video files do not have audio. This allows the nanny cam 816, 818, and 820 to avoid possible legal restrictions on audio taping without permission. The shell of the nanny cam 816, 818, and 820 can look like a picture frame 816, a book 818, a clock 820 or another household object. The nanny cam 816, 818, and 820 can be or include an operable clock.

In one embodiment, a nanny cam includes a camera; and a mount adapted to receive a portable media unit. The mount includes a connector adapted to send files to the portable media unit.

A recess in the nanny cam can receive the portable media unit. The connector can be fixed within a mount to connect with a connector on the portable media unit. In one embodiment, the recess is sized to fit a portable media unit, such as an iPod®, and an insert can be placed in the recess to fit smaller sized devices, such as the iPod® Mini.

In one embodiment, the connector can also be adapted to provide power to the portable media unit. The 32-pin port connector used with the iPod® is an example of a connector that can be used for both a power transfer to the portable media unit and to obtain an audio signal from the portable media unit. The 32-pin port connector of the iPod® includes left/right analog audio input, left/right analog audio output, USB connection pins, Firewire connection pins, a device id pin and a power pin.

In one embodiment, the connector can be a part of a removable module. The module can have an interface with the remainder of the nanny cam to allow power to be input and audio or together signals to be output. Other modules, such as a hard disk module or flash memory connector module, can be substituted for the module with a portable media unit connector.

The nanny earn can include a wall socket plug and a transformer to provide DC power to the portable media unit. Alternately, a battery can be used. The connector can be adapted to provide power to the portable media unit. The nanny cam can include both a wireless connection unit and a connector.

FIG. 29 is a functional diagram of a nanny cam 830. In this embodiment, the camera 832 is used to obtain video or still images. The processor 834 can store the pictures of the videos in an internal memory 836. The picture frame 830 can also have a wireless connection unit 838 to transfer the video picture files to a portable media unit 840. The connection can be through the wireless connection unit 838 or through a direct connection with the connector 842. The connector 842 can also supply power by having a plug 844 provide AC power to a transformer 846 to provide DC power to the connector 842 and thus the portable media unit 840. Alternately, a battery can be used in the nanny cam 830.

FIG. 30 shows a nanny cam 850 with a mount 852 including a connector 854 for connecting to a portable media unit 856.

Referring to FIG. 31, one embodiment of the present invention is a picture frame display 858 comprising a display 860 and a mount adapted to receive a portable media unit 862, the mount including a connector adapted to receive files from the portable media unit 862 to show in the display 860.

The connector, like in FIG. 30, can be adapted to provide power to the portable media unit 862. The picture frame display 858 can include both a wireless connection unit and a connector. The display 858 can be a video or still picture display. The files can be video or still picture files.

One embodiment of the present invention is a picture frame 858 comprising a display 860 and a wireless connection unit adapted to receive files from a portable media unit 862.

FIG. 32 shows a functional diagram of a picture frame 864. Picture frame 864 includes a display 866. The display 866 can display still or video pictures. A processor 868 can be used to control the updating of the display 866. Video and still picture files can be provided from the internal memory 870 or from the portable media unit 872. Files from the portable media unit 872 can be received through a wireless connection unit 874 or a connector 876. The connector 876 can provide DC power using the transformer 878 and plug 880 or by using a battery.

In one embodiment, the picture displayed in the picture frame 874 can be selected based on an input by the user other than explicitly selecting the picture. For example, based on a song being played or a selected playlist, the portable media unit 872 can transmit a picture or video to the picture frame 864.

One embodiment of the present invention is a portable video player comprising a video display and a connector adapted to transfer video from a personal media unit.

The portable media unit can be any portable unit including an MP3 player, a radio, a Compact Disk (CD) player or a video player, such as a portable digital video player that stores digital video files. The portable media unit can include memory, such as a hard disk and/or flash memory, a processor, operating software, display screens, connectors, input elements, speaker and/or earphones.

In one embodiment, the connector can also be adapted to provide power to the portable media unit. The 32-pin port connector used with the iPod® is an example of a connector that can be used for both a power transfer to the portable media unit and to obtain an audio signal from the portable media unit. The 32-pin port connector of the iPod® includes left/right analog audio input, left/right analog audio output, USB connection pins, Firewire connection pins, a device id pin and a power pin. The connector can be adapted to provide power to the portable media unit. The portable video player can include both a wireless connection unit and a connector.

In one embodiment, the connector can be a part of a removable module. The module can have an interface with the remainder of the portable video player to allow power to be input and audio or other signals to be output. Other modules, such as CD, tape or DVD player modules, radio modules and the like, can be substituted for the module with a portable media unit connector.

FIG. 33A illustrates a portable video player 900. The portable video player 900 can be a portable TV or monitor, a portable VCR, a portable DVD player or a portable media player with a hard disk and a video display screen. The portable video player 900 can include stored media playback capability but this is not required. In the example of FIG. 33A, the portable video player 900 includes an additional video source, in this case a DVD drive 902. The portable media unit 904 can connect to the portable video player 900 using connector 906. In the example of FIG. 33A, the portable media unit 904 fits into a recess 908. The portable video player 900 includes a display screen 910 which can display a video from the portable media unit 904 and/or the DVD drive 902. The portable video player 900 also can include speakers 912 and 914. The portable video player 900 can also include a control input 916 for controlling the selection of media from the portable media unit 904.

A door (not shown) can cover the portable media unit 904 while it is positioned in the recess 908 connected to the connector 906.

FIG. 33B illustrates an alternate embodiment in which a portable video player 920 includes a mount 922 with connector 924 for connecting to a portable media unit. In this embodiment, the portable media unit can extend vertically from the device.

In one embodiment, a portable video player comprises a video display and a wireless connection unit adapted to obtain video from a personal media unit.

The wireless connection unit can use a protocol such as a 802.11 protocol (including 802.11a and 802.11g protocols), a Bluetooth protocol and/or other wireless protocols (including other wireless network protocols). The portable video player can include a processor internal or external to the wireless connection unit to help implement the wireless protocol.

The wireless connection unit can be built into the portable video player. Alternately, the wireless connection unit can be a wireless connection card adapted to connect to a port on the portable video player. Examples of wireless connection cards include PCMCIA cards that connect to a PCMCIA port.

The wireless connection unit can include a transceiver to send information to the local unit. For example, the transceiver can send information related to the wireless link status to the portable connection unit.

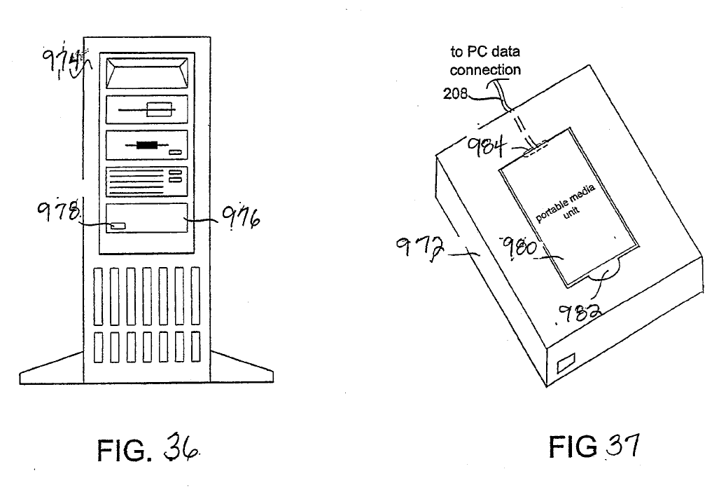

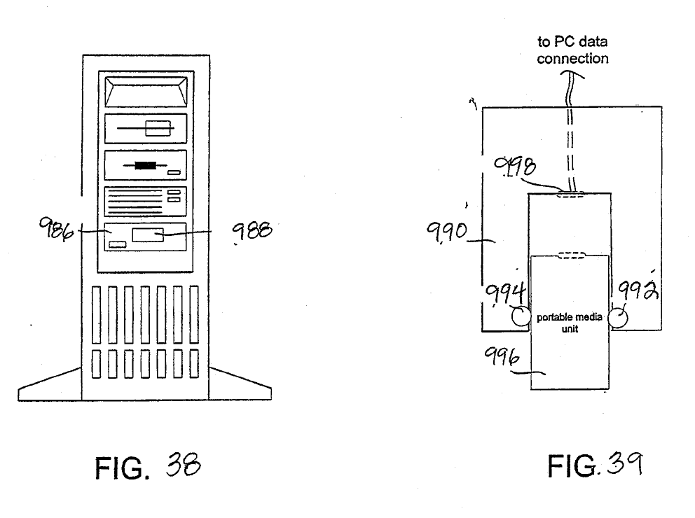

FIG. 34 illustrates an example in which a portable video player 926 includes a wireless connection unit 928 for connecting to a portable media unit 930. A second wireless connection unit can be a part of or can be an add-on to the portable media unit 930. An add-on wireless connection unit can connect to a port connector on the portable media unit 930.

Media from the portable media unit 930 can be played by the portable video player 926. The media can be transferred across the wireless connection through the wireless connection 928. The portable video player 926 can also include a display screen 932, speakers 934 and 936, control element 938, and additional video source such as a DVD drive 940.

FIG. 35 illustrates a functional diagram of a portable video player 942 of one embodiment of the present invention. The portable video player 942 includes a mount 944 which can connect to a portable media unit 946 using connector 948. Media from the portable media unit 946 can be sent to a processor 950 to be displayed on a display screen 952 and audio played on speakers 954. The control element 956 can be used to select media from the portable media unit 946. The memory 958 can store media files and/or buffer media for display using the display screen 952 and speakers 954. Alternately, or in combination, the wireless connection unit 960 can interconnect with the portable media unit 962 to provide media to display on the display screen 952 and speaker 954.

In one embodiment, the connector 948 can provide power to recharge the portable media unit 946. The portable video player 942 can include a battery 964 which can be recharged using a transformer 966 and power management unit 968. Alternating current (AC) power from plug 970 can be converted in the transformer 966 to provide DC power to the connector 948 and to the portable media unit 946, as well as to recharge the battery 964. When the AC cord is not plugged in, battery power can be provided from the battery 964 to the power management unit 968 which can provide power to the connector 948. In one embodiment, the power management unit 968 provides power to all of the electronics of the portable video player 942.

In one embodiment, an enclosure unit for a portable media unit comprises a mechanism adapted to receive a portable media unit and a connector in the mechanism adapted to transfer information from the portable media unit to a computer, wherein the mechanism has a closed position in which the portable media unit is not exposed.

The enclosure unit can allow for the enclosure of the portable media unit so that the portable media unit batteries can be recharged, the portable media unit can be synced up with the computer, and desk clutter can be reduced.

FIGS. 36 and 37 show an embodiment wherein the mechanism is a tray 972. The tray 972 can move between an open and closed position.

The portable media unit can be any portable unit including an MP3 player, a radio, a Compact Disk (CD) player or a video player, such as a portable digital video player that stores digital video files. The portable media unit can include memory, such as a hard disk and/or flash memory, a processor, operating software, display screens, connectors, input elements, and speakers and/or earphones.

A recess in the tray 972 can receive the portable media unit. The connector can be fixed within a mount to connect with a connector on the portable media unit. In one embodiment, the recess is sized to fit a portable media unit, such as an iPod®, and an insert can be placed in the recess to fit smaller sized devices, such as an iPod® Mini.

In one embodiment, the connector can also be adapted to provide power to the portable media unit. The 32-pin port connector used with the iPod® is an example of a connector that can be used for both a power transfer to the portable media unit and to obtain an audio signal from the portable media unit. The 32-pin port connector of the iPod® includes left/right analog audio input, left/right analog audio output, Universal Serial Bus (USB) connection pins, Firewall connection pins, a device id pin and a power pin. The enclosure can include a wall socket plug and a transformer to provide DC power to the portable media unit. Alternately, the USB cable can be used to obtain the power for the portable media phase and any motor of the enclosure unit. The connector can be adapted to provide power to the portable media unit.

In one embodiment, the connector can be a part of a removable module. The module can have an interface with the remainder of the device to allow power to be input and audio or other signals to be output. Other modules, such as CD, tape or DVD player modules, radio modules and the like, can be substituted for the module with a portable media unit connector.

The transferred information can include audio signals and digital audio files or other digital files including digital media files.

FIG. 36 shows a computer tower 974. The computer tower 974 can have a number of elements attached to the computer such as a disk drive, a CD-Rom, a DVD player and the like. In the example of FIG. 36, an enclosure unit 976 is used. The enclosure unit 976 can be used to store a portable media unit such that it is protected and out of sight. The enclosure unit 976 can have a pull door, or in one embodiment, can use a motor in a similar manner as a conventional CD player. In this example, button 978 is used to open the tray that closes the portable media unit.

FIG. 37 is a diagram illustrating an example with a tray 972. The portable media unit 980 fits within a slot 982 in the tray 972. A connector 984 can be used. In one embodiment, a wire such as a cable is used to connect the connector 984 to a computer. The wire can be a USB connector which can connect to a USB connection on the back of the computer tower.

In one embodiment, the enclosure unit is a tray with a mount adapted to receive a portable media unit 980. The mount can include a connector adapted to transfer information from the portable media unit 980 to a computer. The enclosure unit has a closed position in which the portable media unit 980 is not exposed.

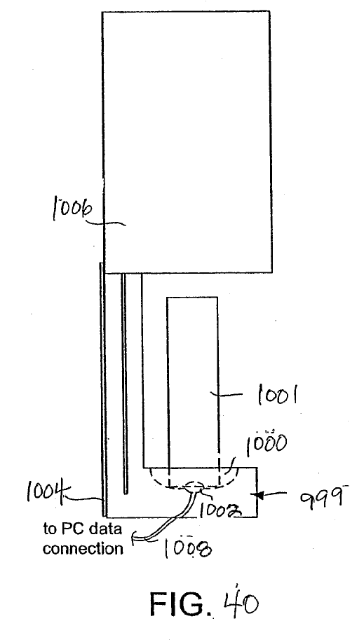

FIGS. 38 and 39 illustrate an example where the mechanism of the enclosure unit 986 is an insertion unit 988. Like a cassette tape insertion unit, the enclosure unit 986 can receive a portable media unit and move the portable media unit from an exposed position to an enclosed position. The portable media unit can be docked with a connector in the enclosed position. In the embodiment shown in FIG. 39, the enclosure unit 990 uses rollers 992 and 994 to move the portable media unit 996 in and out of the enclosure unit 990. The rollers 992 and 994 can be powered and can operate in response to a sensor that detects the insertion of the portable media unit 996. The rollers 992 and 994 can be constructed of a material, such as rubber, that can operably engage the portable media unit 996 to move it inside and outside of the enclosure unit 990. The portable media unit 996 can dock with the connector 998 on the enclosure unit 990. In an alternate embodiment, the enclosure unit 990 can use a mechanical unit located near the connector 998 to push the portable media unit 996 out of the enclosure unit 990.

In the embodiment shown in FIG. 40, a device 999 comprises a housing and a mount 1000 adapted to receive a portable media unit 1001. The mount 1000 includes a connector 1002 adapted to transfer information from the portable media unit 1001 to a computer. The housing has an attachment element 1004 for physically attaching the device 999 to the computer. The attachment element 1004 can be a sticky pad or other adhesive or mechanical attachment unit.

In the example of FIG. 40, the device 999 is adapted to enclose the portable media unit 1001. FIG. 40 shows an example where the device 999 has a sliding cover 1006. In one embodiment, the controls on the portable media unit 1001 are not exposed in an enclosed position. The connector 1002 can provide power to the portable media unit 1001. A wire 1008 can connect the connector 1002 to a computer.

The wire 1008 can be a USB wire or other data cable such as a firewall cable having multiple active lines. The cable wire can connect to a location on the computer such as in back of the computer tower. In one embodiment, the wire 1008 is adapted to be wound out of a retractable unit. The retractable cable unit is described in U.S. Provisional Application No. 60/609,592 entitled “Device with Speaker and Retractable Cable Unit,” filed Sep. 13, 2004, which is incorporated herein by reference. The retractable cable unit can use a spool under tension connected to the wire 1008. The spool can use a tensioning spring to hold so that the wire 1008 can be wound back up.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An apparatus comprising:
a housing configured to receive a cable module and a holder, wherein the holder is configured to receive a portable media device;
an output device coupled to the housing; and
the cable module comprising a cable configured to move relative to the cable module and to connect with a portable media device to communicate a media signal between the portable media device and the output device.

2. The apparatus of claim 1, wherein the output device comprises a video display.

3. The apparatus of claim 1, wherein the output device comprises an audio device.

4. The apparatus of claim 1, wherein the portable media unit is an audio device.

5. The apparatus of claim 1 wherein the portable media unit is a video device.

6. The apparatus of claim 1, wherein the cable is movable between an extended position in which a portion of the cable is located outside of the cable module and a retracted position in which a larger portion of the cable is located within the cable module.

7. The apparatus of claim 1, wherein the cable is movable between an extended position in which a portion of the cable is located outside of the cable module and a retracted position in which a larger portion of the cable is located within the cable module, wherein the cable module further comprises a tensioning spring configured to automatically pull the cable from the extended position to the retracted position upon activation.

8. The apparatus of claim 1, wherein the cable comprises a first end and a second end, wherein the first end is coupled to an electronic circuit associated with the output device, and wherein the second end comprises a connector configured to couple the cable to the portable media device.

9. The apparatus of claim 1, wherein the cable comprises a first end and a second end, wherein the first end is coupled to an electronic circuit associated with the output device, and wherein the second end comprises a connector configured to couple the cable to the portable media device, wherein the connector comprises a jack plug or a multipin connector.

10. The apparatus of claim 1, wherein the cable module is removably coupled to the housing.

11. The apparatus of claim 1, wherein the housing comprises a recess adapted to hold the cable module.

12. The apparatus of claim 1, wherein the housing comprises a recess adapted to hold the cable module and covered by a door.

13. The apparatus of claim 1, wherein the cable is adapted to transfer power to the portable media device.

14. The apparatus of claim 1, wherein the holder is removably coupled to the housing.

15. The apparatus of claim 1, wherein the holder comprises a backrest configured to support the portable media device.

16. The apparatus of claim 1, wherein the holder further comprises:
a first compartment configured to receive the portable media device; and
a second compartment configured to receive the cable module.

17. The apparatus of claim 1, wherein the holder further comprises:
a first compartment configured to receive the portable media device; and
a second compartment configured to receive the cable module, wherein the second compartment is covered by a lid.

18. The apparatus of claim 1, wherein the holder further comprises:
a first compartment configured to receive the portable media device; and
a second compartment configured to receive the cable module, wherein the second compartment comprises an ejection mechanism configured to eject the cable module located within the second compartment upon activation and is covered by a lid.

19. The apparatus of claim 1, wherein the housing further comprises a chair or a computer.

20. The apparatus of claim 1, further comprising a wireless connection unit coupled to the housing, wherein the wireless connection unit is configured to communicate with a local device via a wireless communication protocol.

21. The apparatus of claim 20, wherein the local device comprises at least one of a portable media player, a controller, a speaker, a camera, or a display.

22. The apparatus of claim 20, wherein the wireless communication protocol comprises at least one of a IEEE 802.11 communication protocol or a Bluetooth protocol.

23. The apparatus of claim 1, wherein the portable media device comprises at least one of a portable music player, a portable video player, or an MP3 player.

24. The apparatus of claim 1, wherein the media signal comprises at least one of an analog audio signal, a digital audio signal, a video signal, or a combination audio and video signal.

25. The apparatus of claim 1, wherein the output device comprises a control element.

26. The apparatus of claim 1, wherein the holder is weatherproof.

27. A cable module comprising: a cable configured to move relative to the cable module housing and to connect a portable media device to an output device such that a media signal from the portable media unit can be transmitted to the output device.

28. The cable module of claim 27, wherein the media signal is electronic.

29. The cable module of claim 27, wherein the cable is movable between an extended position in which a portion of the cable is located outside of the cable module and a retracted position in which a larger portion of the cable is located within the cable module.

30. The cable module of claim 27, wherein the cable is movable between an extended position in which a portion of the cable is located outside of the cable module and a retracted position in which a larger portion of the cable is located within the cable module, wherein the cable module further comprises a tensioning spring configured to automatically pull the cable from the extended position to the retracted position upon activation.

31. The cable module of claim 27, wherein the cable comprises a first end and a second end, wherein the first end is coupled to an electronic circuit associated with the output device, and wherein the second end comprises a connector configured to couple the cable to the portable media device.

32. The cable module of claim 27, wherein the cable comprises a first end and a second end, wherein the first end is coupled to an electronic circuit associated with the output device, and wherein the second end comprises a connector configured to couple the cable to the portable media device, wherein the connector comprises a jack plug or a multipin connector.

33. A method of selecting a playlist comprising:
storing a plurality of playlists;
receiving an input associated with a condition at a portable media unit; and
controlling the portable media unit to initiate a selection from the stored plurality of playlists based on the received input.

34. The method of claim 33, wherein receiving the input associated with the condition comprises receiving at least one of an environmental condition, a time condition, or a user id.

35. The method of claim 33, wherein receiving the input associated with the condition comprises receiving at least one of temperature information, humidity information, rainfall information, or wind speed information.

36. The method of claim 33, wherein controlling the portable media unit comprises selecting at least one playlist from the plurality of playlists based on the condition.

37. The method of claim 36, wherein selecting the at least one playlist comprises selecting a warm weather playlist or a cold weather playlist.

38. The method of claim 33, wherein controlling the portable media unit comprises personalizing a display of the portable media unit based on the condition.

39. The method of claim 38, wherein personalizing the display comprises displaying at least one playlist from the plurality of playlists based on the condition.

40. The method of claim 33, further comprising determining the condition via a wireless communication protocol.
